(19) United States
(12) Patent Application Publication
(10) Pub. No.: US 2013/0218616 A1
(43) Pub. Date: Aug. 22, 2013

(54) METHOD OF PREDICTING A PLURALITY OF BEHAVIORAL EVENTS AND METHOD OF DISPLAYING INFORMATION

(71) Applicant: STEVEN G. PINCHUK, BOYNTON BEACH, FL (US)

(72) Inventor: STEVEN G. PINCHUK, BOYNTON BEACH, FL (US)

(21) Appl. No.: 13/845,314

(22) Filed: Mar. 18, 2013

Related U.S. Application Data
(63) Continuation of application No. 12/836,244, filed on Jul. 14, 2010.

(51) Int. Cl. G06Q 10/06

(52) U.S. Cl. CPC G06Q 10/063
USPC 705/7.11

(57) ABSTRACT

A computerized method includes: programming a computer to statistically analyze data describing a plurality of types of behavior for a plurality of entities in order to construct a plurality of behavioral patterns; and programming the computer to compare data describing an entity with the plurality of behavioral patterns in order to use one of the plurality of behavioral patterns as a predictive behavioral pattern predicting a plurality of behavioral events for one type of behavior of the entity occurring over any amount of time up to a lifetime of the entity. A computerized method of displaying information includes: programming a computer such that a plurality of windows are displayed by a display device and show a plurality of live systems. The windows show where in the plurality of live systems, the computer derived the information that is requested by the user and that is displayed.

### CROSS-REFERENCE TO RELATED APPLICATIONS

This is a divisional application of U.S. patent application Ser. No. 12/836,244, filed Jul. 14, 2010; which claims the priority under 35 U.S.C. §119(e) of provisional application No. 61/225,209 filed Jul. 14, 2009, provisional application No. 61/348,347 filed May 26, 2010, and provisional application No. 61/358,878 filed Jun. 25, 2010; the prior applications are herewith incorporated by reference in their entirety.

### BACKGROUND OF THE INVENTION

1. Field of the Invention

The invention relates to a computerized method of predicting a plurality of behavioral events of an entity. Those predictions are then used to optimize the interactions between a plurality of entities and the organization. The computerized method then optimizes the equilibrium between all of the internal areas of the organization based on the results of these predicted interactions. For example, in the case where the entity is a customer or a supplier of an organization, the computerized method can predict the future purchases of the customer or the future dependability of the supplier of the organization. The invention also relates to a computerized method of displaying requested information on a display by programming a computer to display a plurality of windows that show a plurality of live systems and that show where in the plurality of live systems, the computer derived the requested information.

2. Description of the Related Art

It is common to form a market segment by grouping together a number of customers, which is one type of entity, based on the demographics of the customers or perhaps based on a small number of other common characteristics of the customers. The same marketing efforts are then directed to all of the customers in that market segment.

### BRIEF SUMMARY OF THE INVENTION

It is an object of the invention to program a computer to predict all of the probable future behaviors of an entity that interacts with an organization so that pricing, marketing, supply chain and any other efforts can be more accurately targeted to the entity based on the long term future value and interests of the entity.

It is an object of the invention to program a computer to predict the future behavior of all types of entities that interact with the organization.

It is an object of the invention to program a computer to compare the past behavior or behavioral events of an entity with the behavioral events that are indicated by a plurality of behavioral patterns in order to find one of the plurality of behavioral patterns that can serve as a predictive behavioral pattern capable of predicting the future behavioral events of the entity. At the time of the comparison, the plurality of behavioral patterns is known since they have already been constructed by a computer. The predictive behavioral pattern is the one of the plurality of known behavioral patterns having behavioral events that best match the past behavioral events of the entity. When a predictive behavioral pattern is found in this manner, the behavioral events of the predictive behavioral pattern, which occur after the behavioral events that have been matched with the known behavioral events of the entity, serve as a reliable prediction of the future behavioral events of the entity.

With the foregoing and other objects in view there is provided, in accordance with the invention, a computerized method of predicting a plurality of behavioral events of an entity. The method includes programming a computer to construct a plurality of behavioral patterns by statistically analyzing data describing a plurality of entities. In the example, where an entity is a customer, the data contains the behavioral events, which have already taken place, of a plurality of customers.

The assumption is that the past behavior, which is statistically similar, of a plurality of entities over a time period can be used to predict the future behavior of an entity that has acted sufficiently similar to that plurality of entities up to a certain point in time, for example, the present time. The method also includes programming the computer to compare the data describing an entity with the plurality of behavioral patterns in order to use one of the plurality of behavioral patterns as a predictive behavioral pattern predicting a plurality of behavioral events of the entity occurring over any upcoming amount of time up to a lifetime of the entity. The predictive behavioral pattern, which predicts a plurality of behavioral events of the entity occurring over any upcoming amount of time up to a lifetime of the entity, can be called an Individual Nano Entity Lifecycle (INEL).

Other features which are considered as characteristic for the invention are set forth in the appended claims.

Although the invention is illustrated and described herein as embodied in a method of predicting a plurality of behavioral events and in a method of displaying information, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a diagram showing an INEL or behavioral pattern;

FIG. 2 is a diagram showing an INEL or behavioral pattern of an entity and the better predicted future behavior pattern given by the INEL;

FIG. 3 is a diagram showing an INEL or behavioral pattern of an entity and the better predicted future behavior pattern given by the INEL;

FIG. 4 is a diagram showing an INEL or behavioral pattern of an entity and showing how INEL's are used to target proactive and reactive marketing actions;

FIG. 5 is a diagram showing an example of a predicted lifecycle and a 15% deviation parameter based around that predicted lifecycle;

FIG. 6 is a diagram showing how an INEL can be used to target entities for promotion;

FIGS. 7 through 11 are diagrams showing different ways that different behavior patterns of an INEL can be graphically displayed;

FIGS. 12, 13 and 14 are diagrams showing a CINEL;

FIG. 15 is a diagram showing a BINEL;

FIG. 16 is a diagram showing the hierarchy of the INEL, CINEL, and SINEL patterns;

FIG. 17 is a diagram showing how similar INEL or SINEL are used to create a benchmark INEL or BINEL;

FIG. 18 is a diagram showing the hierarchy of the individual (INEL), combined (CINEL), meta (MINEL), similar (SINEL), and benchmark (BINEL) classifications;

FIGS. 19 through 22 are diagrams showing examples of a command, control, communications and intelligence entity system interface (C³ISI);

FIG. 23 is a table showing the hierarchy and makeup of different levels of INEL;

FIG. 24 is a plot showing the results of a survey;

FIG. 25 is a flow diagram of an embodiment of a method;

FIG. 26 is a block diagram of a computer;

FIG. 27 is a diagram showing a plurality of behavioral patterns;

FIG. 28 is a diagram showing a common behavioral pattern being formed from specific entity behavioral pattern curves;

FIG. 29 is a diagram showing a comparison between the data describing an entity and a predictive behavioral pattern; and

FIG. 30 is flow diagram of a computerized method implementing a Command, Control, Communication & Intelligence System Interface.

### DESCRIPTION OF THE PREFERRED EMBODIMENTS OF THE INVENTION

This section defines terms and acronyms used in the document. This will also provide an understanding of the differences between what these terms in connection with the invention and how these same terms are used in the prior art. Because of the differences, the inventor has attempted to use some different words and has created some new terminology and acronyms in order to highlight the differences between the prior art and the invention. The explanations given here should not be assumed to be the only explanations given about how the invention works and the details behind it.

The meaning of a few terms used in the description will be discussed.

The word “entity” is anything that has a distinct, separate existence, though it need not be a material existence. A customer is an entity; however, all entities are not customers. The term, “entity” is used to denote any person that interacts with an organization in some manner, or any organization that interacts with another organization in some manner. An entity could be, for example, a customer or a supplier of an organization.

In this description the word “action” or “actions” is intended to mean any action, interaction, reaction, effort, decision, or lack of action in response to a stimulus or change in current status or decision. It may be conscious or unconscious, precipitated or un-precipitated by an entity. Any change in the status quo can be considered an action, whether that action is precipitated by an entity or by the organization. One of the goals of the predictive analytics described herein is to understand all of the actions that were taken by entities which interact with the organization on the demand, supply, enterprise or any other level(s) of the business.

In this description, the actions which are being predicted and/or tracked for an entity may not constitute what are traditionally called actions. Traditional entity actions are usually when an entity buys something, makes requests of the organization or in some way directly interacts with the organization. In this description it is important that every interaction with an entity is captured. Interactions which do not appear to be actions can be very useful in predicting the future behaviors of an entity when using statistical methods that consider all data points for an entity. For example, how many times have they visited your website, replied to your e-mails, how many times have they been in your store, have they joined your loyalty club—and at what point in their lifecycle? All of these actions can be very good indicators of the future behavior of an entity. Even actions which at this time seem to have no value need to be captured and stored, since in the future they may become very valuable for predicting certain behaviors.

Demand and/or supply and/or enterprise and/or any other areas include all possible user defined combinations of areas in an organization.

An Individual Nano Entity Lifecycle (INEL) and/or Individual Nano Entity Lifecycles (INEL) describe the behavioral patterns of an entity. The word “individual” stands for the fact that this is one lifecycle (or behavioral pattern) for one type of behavior (dimension or attribute) for one entity. It is being calculated separately from the other lifecycles for that entity. Entities can have many INEL's.

The word “dimension” includes any type of behavior that an entity has either with an organization or outside of the organization. In an example where the entity is an individual, a type of behavior that occurs outside of an organization includes, for example, the type of car owned by an entity, the marital status of the entity, the age, the credit score, or anything else that might be predictive of their future habits. In an example where the entity is an organization, a type of behavior that occurs outside of an organization includes number of members or employees, the number of years in existence, revenues, profits, past performance, and their position in the marketplace. Examples of types of behavior that an entity with an organization includes revenue spent with the organization, frequency of purchases, products purchased, visits to the website of the organization, and the response to communications.

The word “nano” indicates that this is being calculated at the lowest possible level of behavior—the smallest action that an entity is expected to take, as long as there is enough data and history to statistically predict this action at a level that has enough confidence to be acceptable and reliable enough to be used.

The word “lifecycle” is all the past and predicted future actions for this entity for a dimension, whether or not at this time they appear to be materially important for the organization.

The predicted behavior that can be obtained is not just the next event in the behavior of an entity, or the next event for a whole market segment, along one dimension of their interaction with an organization. In this description the goal is to understand all the INEL's for an entity that describes all the future actions that an entity (not just a customer) is expected to do in the future with an organization. Across all the dimensions in which they will interact with the organization, for as long into the future as there is a reasonable predictive analytics foundation to extrapolate or predict the actions of that entity given their current status and the information that we have about them at that point in time.

In this description, a lifecycle is a series of future actions associated with one dimension, that are being predicted and that are linked together to form a behavioral pattern. As described earlier, lifecycles are aggregated into many different classifications, which are built from the “ground up” INEL level to describe all the entity's and entities' actions.

In this description, the expected lifecycle of an entity is not defined as a set of predefined stages which the entity passes through. Using stages that were defined before determining what the lifecycle truly is based on the entities data and history. In the present invention, the events are defined based on the historical actions of other entities that exhibited similar behaviors. As the entities, which are the basis of the analysis of already exhibited behavior for that the entity that is being studied, change their behavior, this automatically changes the expected behavioral path of other entities that are expected to pass through that path. The stages are not static. The lifecycles are not static. They are defined based on live and ongoing analysis of existing entities behavior. As behavior patterns change, the expected future actions of entities that are on this lifecycle are also expected to change.

In the present invention, there is a concept that the behavior of an entity needs to be broken into the smallest possible dimensions that are predictable and then aggregated into meta-lifecycle classifications. Many predictive analytics models and challenges are best solved by breaking the problem down into the smallest possible level which can be statistically solved, and then rolling these detailed results back up into a larger deliverable or understanding. Looking at the behavior patterns at the smallest possible level also allows you to use predictive analytics for the entities to capture changes at their earliest occurrence. This allows trends to be established much earlier than waiting for them to be visible in the larger meta-patterns. It also allows you to understand exactly where the changes are coming from where if you were just looking at the meta-pattern you would not really see what was changing down at the detailed level.

In the present invention, the lifecycle concepts will be applied to far more than only to customers. Applying these concepts to all entities that the organization reacts with both on the demand and/or the supply side and/or the enterprise level(s) is unique.

The term, “behavioral event” is used to denote any action or interaction of the entity with an organization. The term, “behavioral event” also includes any state of being that describes an entity. A state of being could be a demographic factor, a financial status, or any other factor describing the makeup of an entity that has a bearing on the pattern of behavior of the entity.

In an example where the entity is a consumer of an organization, one type of a behavioral event occurs when a consumer makes a purchase from the organization. A behavioral event could also be defined to occur when an entity does not perform an action. For example, when an entity does not take an action under certain circumstances. In another example where the entity is a supplier that supplies goods and/or services to an organization, one type of a behavioral event occurs when the supplier delivers the goods and/or services on time.

The term, “behavioral pattern” is a pattern that indicates when an entity has performed certain behavioral events. A behavioral pattern can be constructed as a curve with the behavioral events plotted as a function of time. The terms, “Individual Nano Entity Lifecycle” (INEL) are also used herein to refer to a behavioral pattern.

The term “computer” refers to any electronic programmable device with a microprocessor that possesses computing power which is sufficient to perform the method and that receives input, manipulates data, and provides useful output. A computer could be, for example, a personal computer, a laptop computer, a computer workstation, a supercomputer, or any other similar device.

FIG. 26 is a block diagram of a computer 10 that is programmed to perform the different embodiments of the invention. The invention relates to a computerized method of predicting a plurality of behavioral events of an entity in which the computer 10 is programmed to perform the steps of the methods that are described. It should be understood that the invention also relates to a set of computer executable instructions for performing the steps of the method, and to a computer 10 that has been programmed to perform the steps of the methods.

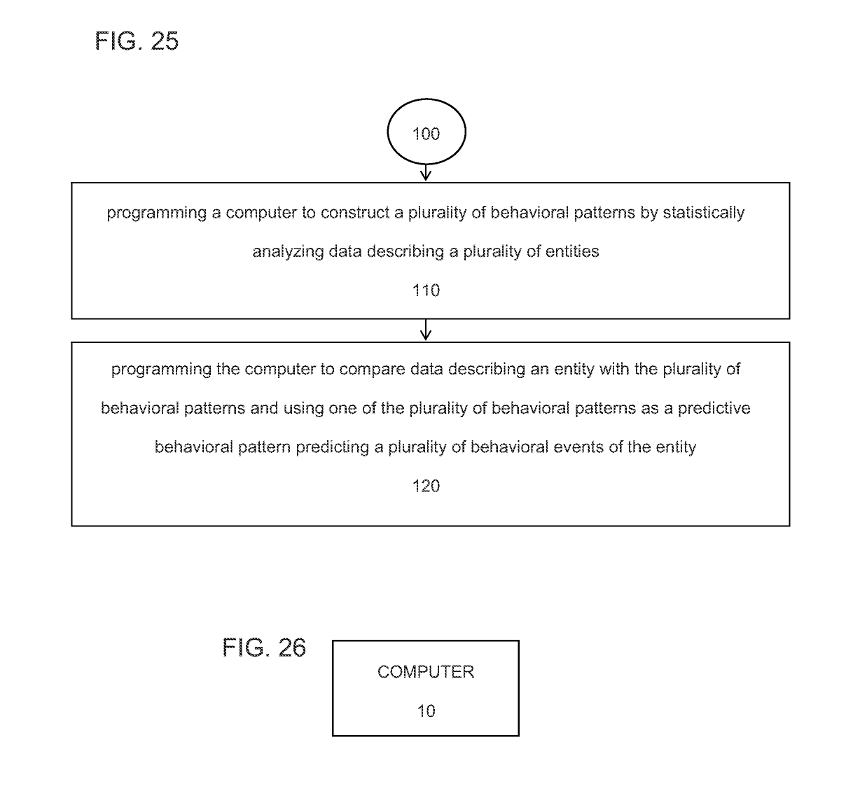

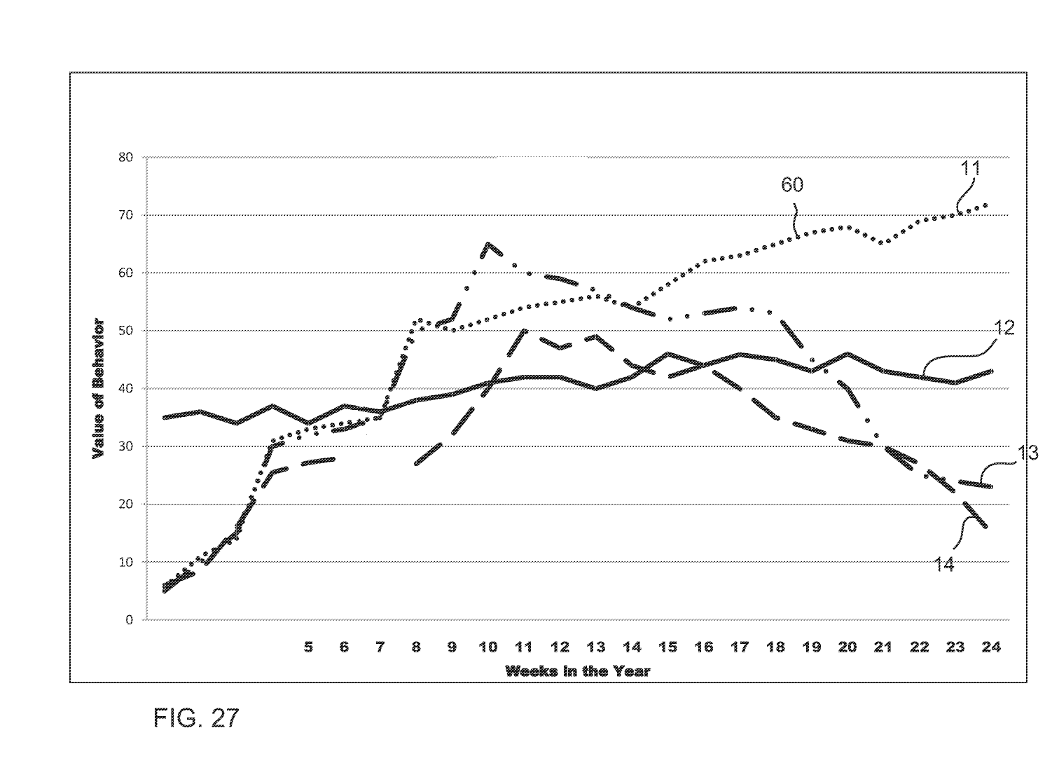

The following description is provided to assist the reader in understanding the steps of the methods that are described. FIG. 25 shows a block diagram of an exemplary embodiment of a computerized method 100 of predicting a plurality of behavioral events of an entity. The method 100 includes a step 110 of programming a computer 10 to construct a plurality of INEL's or behavioral patterns 11, 12, 13, 14 by statistically analyzing data describing the behavior of a plurality of entities. The statistical analysis that is described in this example is performed on a set of data that describes one particular type of behavior of the plurality of entities. However, it should be understood that the analysis, which is described below, is also performed on other sets of data; each set of data describing a different type of behavior of the plurality of entities. FIG. 27 is a diagram showing examples of a plurality of behavioral patterns 11, 12, 13, 14. One example of constructing a plurality of behavioral patterns 11, 12, 13, 14 will be described below.

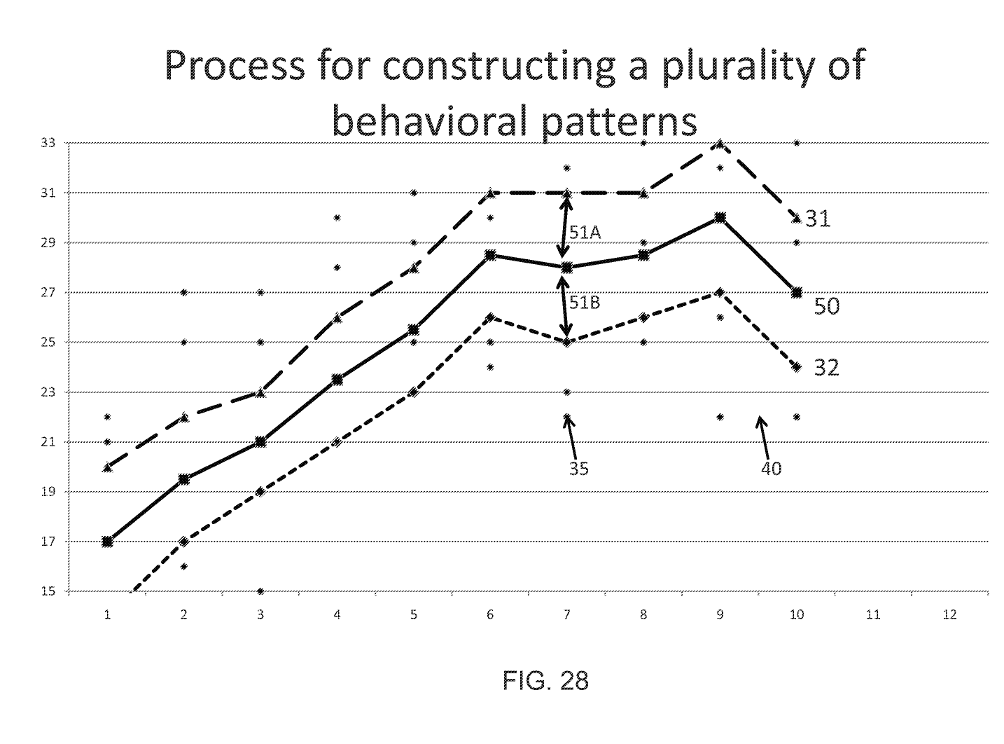

FIG. 28 shows the data points 35 of a set of data 40 that is supplied to the computer 10. The set of data 40 is historical data that indicates the past behavior or behavioral events of a plurality of entities for “one type of behavior”. When a particular entity makes a purchase, which could be, for example, the purchase of a big screen television, many different types of behavioral events can be identified. The model of the big screen television is a first type of behavioral event. The purchase price of the big screen television is a second type of behavioral event. The time of purchase is a third type of behavioral event. The place of purchase is a fourth type of behavioral event. Of course additional types of behavioral events could be associated with the purchase of the big screen television. The four types of behavioral events that have been discussed in association with the purchase of the big screen television provide four data points that would each be included in different sets of data. It should be clear that each set of the data includes data points related to only one particular type of behavioral event.

When that same entity makes a subsequent purchase, for example, the purchase of a Blue Ray™ DVD (digital video disk) player, the purchase price of the DVD player, the time of purchase of the DVD player, and place of purchase of the DVD player are four different types of behavioral events. Each one of those behavioral events provides a new data point that could be included in a set of data that only includes data points related to one particular type of behavioral event. Each set of data, such as data 40, is preferably updated in real time when a new behavioral event occurs.

The subsequent purchases and other types of behavior of the entity would also provide additional data points and each one of the data points would be included in a set of the data for the appropriate type of behavioral event. In this manner, a set of data 40 includes the behavior of the entity over a significant period of time for one type of behavior. Of course the goal is to obtain information indicating the behavioral events that have taken place over the entire lifetime or the effective lifetime of the entity. It should be understood that the set of data 40 includes information of the behavioral events for the same type of behavior for a number of entities. It should also be understood that the number of entities is large enough such that the data 40 enables statistically significant information to be obtained about the behavior patterns for that type of behavior for an entity or for a number of entities.

In step 110, which is shown in FIG. 25, the computer 10 statistically analyzes the data points of a set of data for one type of behavioral event in order to construct a plurality of behavioral patterns for that type of behavioral event. One example of a plurality of behavioral patterns is illustrated by the plurality of behavioral patterns 11, 12, 13, 14 shown in FIG. 27. Of course in practice, the computer 10 would construct many more behavioral patterns. The number of behavioral patterns that can be constructed depend on the number of unique entity behaviors that entities exhibit for that particular type of behavioral event.

One example of a process for constructing a plurality of behavioral patterns 11, 12, 13, 14 for a particular type of behavioral event can be understood by referring to FIG. 28. This process begins with constructing a plurality of entity specific behavioral pattern curves 31 and 32 from the data points 35 for one type of behavioral event contained within the set of data 40. Each one of the plurality of entity specific behavioral pattern curves 31 and 32 describes the behavioral events of a particular entity for one type of behavior. Even though only two entity specific behavioral pattern curves 31, 32 are illustrated, it should be understood that the computer 10 will construct many more entity specific behavioral pattern curves 31, 32 from the data points 35 within the data 40.

The computer 10 then performs a statistical analysis on the entity specific behavioral pattern curves 31, 32 to see which ones statistically follow a common behavioral pattern and to construct that common behavioral pattern 50. The computer 10 also calculates the deviations 51A, 51B between each one of the entity specific behavioral pattern curves 31, 32 and the common behavioral pattern 50. This common behavioral pattern 50, which is formed from the entity specific behavioral pattern curves 31, 32, is used to form one of the plurality of behavioral patterns (11). The deviations between each of the entity specific behavioral pattern curves 31, 32 and the common behavioral pattern 50 are also saved and associated with the one of the plurality of the behavioral patterns (11) that is formed by the common behavioral pattern 50.

The process is repeated in order to form other ones of the plurality of behavioral patterns 12, 13, 14. To be precise, the process is repeated to form behavioral pattern 12, behavioral pattern 13, behavioral pattern 14, and other behavioral patterns that are not illustrated. The number of behavior patterns that are created depends on how many data points 35 there are in data 40 and how entity specific behavioral pattern curves are created that are not statistically close enough to be considered similar. The measure of how different a curve has to be to not fit into a behavior pattern is user defined and can change based on the goals of the analysis and the available data.

It is preferable to update the set of data 40 in real time so that as new behavioral information is obtained, the computer 10 can update the plurality of specific behavioral pattern curves 31, 32 and the plurality of behavioral patterns 11, 12, 13, 14 that are formed from the specific behavioral pattern curves 31, 32.

FIG. 25 shows that step 120 is performed after the plurality of behavioral patterns 11, 12, 13, 14 have been constructed in step 110. Step 120 includes programming the computer 10 to statistically compare the data describing the known behavioral events of a particular entity with the plurality of behavioral patterns 11, 12, 13, 14. The comparison is performed to find one of the behavioral patterns 11, 12, 13, 14 that is statistically a close enough match to the actual historical data from an entity that it is deemed suitable to be used as a predictive behavioral pattern that can predict the future behavioral events of the particular entity. The user can define the degree of statistical match between the historical data of an entity and a particular one of the behavioral patterns 11, 12, 13, 14 that is sufficient to select a particular one of the behavioral patterns 11 as the predictive behavioral pattern 60 (See FIG. 27). The user can change the degree of statistical match based on the goals of the analysis and the data that is available.

In FIG. 27, the computer 10 has found that the behavioral pattern 11 is suitable to be used as a predictive behavioral pattern 60 that predicts a plurality of behavioral events of the particular entity. As shown in step 120 of FIG. 25, the computer 10 can then proceed to use the behavioral pattern 11, which has been selected as the predictive behavioral pattern 60 (FIG. 27) to predict a plurality of behavioral events of one type of behavioral event of the particular entity.

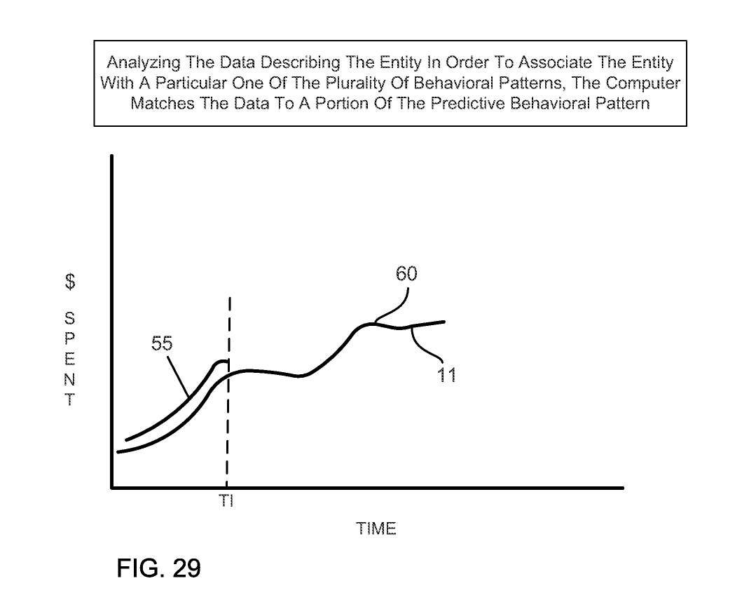

FIG. 29 is a diagram including a historical behavioral curve 55, which is formed from the data describing the behavioral events of the particular entity for one type of behavioral events. The behavioral curve 55 shows the past behavioral events of a particular entity that will have its future behavioral events predicted. As can be seen, the behavioral curve 55 only contains behavioral events up to time T1. The computer 10 compares the behavioral curve 55 with the plurality of behavioral patterns 11, 12, 13, 14, such as the behavioral pattern 11 shown in FIG. 29. As has been previously discussed, the goal is to match the behavioral curve 55 to one of the plurality of behavioral patterns 11, 12, 13, 14 so that the matched behavioral pattern 11 serves as a predictive behavioral pattern 60. The predictive behavioral pattern 60 then predicts that behavioral events occurring after time T1 on the behavioral curve 55 will also occur at a future time for the particular entity.

The degree of deviation between the entity specific behavior pattern curves 31, 32 and the common behavioral pattern 50, which was used to create the behavioral pattern, 11, and the degree of deviation between the historical data from the entity and the behavioral pattern 11 selected by the computer 10 as a match according to their past behavior, are used by the computer 10 to determine how close the entity is expected to follow the behavioral pattern 11 that the computer 10 selected for the entity.

The example just described only involved one set of data 40 that indicates the past behavior or behavioral events of a plurality of entities for “one type of behavior”. It should be understood that in practice the steps described will be repeated for each of a plurality of sets of data, and that each set of data only includes data points of one specific type of behavioral event.

The process described above will produce behavioral patterns 11, 12, 13, 14 for all of the types of behavior or behavioral events for all entities. The behavior of an entity is generally not based on one type of behavior or behavioral event. Decisions are the result of the current environment plus a combination of many behavioral patterns. To accurately apply the predictive nature of the behavior patterns 11, 12, 13, 14 for a type of behavior, the computer 10 or the computer program being executed by the computer 10 needs to access the changes in the environment and factor in those changes to the predictions. The computer 10 also needs to access the impacts that other behavioral patterns for the entity will have on the behavioral pattern that is being predicted. The computer 10 also needs to access any other changes that appear to impact the behavioral pattern that is being predicted and factor in those influences.

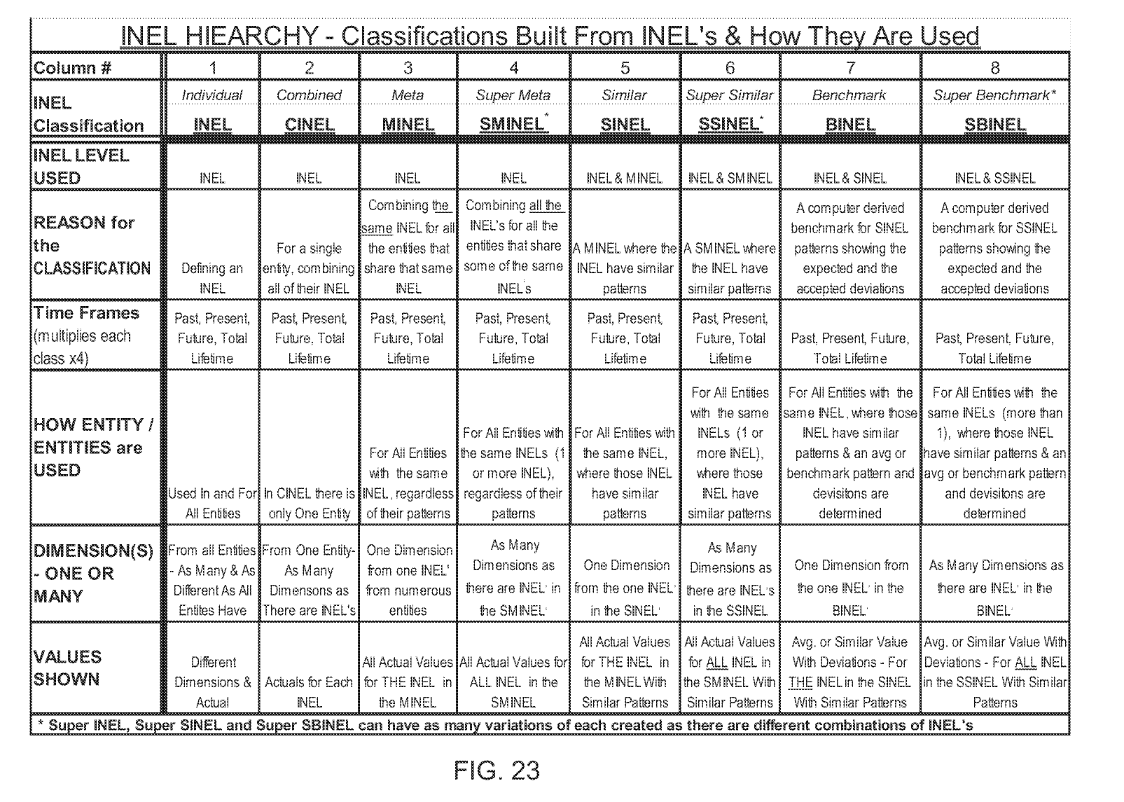

The table in FIG. 23 is explained and used in the numbered paragraphs below, which explain the terminology, composition, classifications and structure in Individual Nano Entity Lifecycle Management (INELM).

Column 1—INEL

One of the keys to entity optimization is to be able to statistically separately determine each entity's historical Individual Nano Entity Lifecycle (INEL) for each dimension (behavior pattern for a type of behavior) that they exhibit. While INEL have both past and future predicted behavior patterns for the entity, for now we will focus on how the past behavior patterns of an entity are used to understand, classify and discover an entity's INEL and other hierarchical classifications. An entity has many past behavior patterns or past INEL. Entities have one past INEL for each dimension of interaction between the entity and the organization or interaction with the entity and with other things that the organization can capture. Multiple entities can have the same INEL's, although their patterns may not be the same. Examples of dimensions of interaction or action can be anything that the entity does that can be captured as part of their broad behavior patterns as an entity. Each dimension is discreet. Purchases, web site visits, calls, responses to promotions or other communications, products, zip code, marital status, cars that are owned, etc. are all different dimensions of action and/or interaction for an entity and each can have its own INEL. An entity can have 3 INEL's captured and tracked by an organization or they can have 30 INEL's, depending on how much they interact with the organization and/or how much the organization knows about the entity. Each INEL is kept and tracked separately. Each action/interaction from a dimension that is tracked using an INEL is updated immediately in the INEL with new data, once it is captured, and that INEL and the entities pattern along that INEL, as well as the patterns for that INEL from all entities, is reanalyzed. INEL are the most elemental component and are the “building blocks” of this invention and all the other lifecycle classifications. They are always being updated, analyzed, changes and trends noted, etc.

Column 2—CINEL

All the INEL for the same entity, which could cover many dimensions and therefore consist of many INEL, are combined into that entity's Combined Individual Nano Entity Lifecycle (CINEL). This acts like a combined profile of the entity. Some of the INEL's can be combined to view in one graph and/or report and some of the INEL's are too different in the dimensions that they cover to combine into one view. However, all the INEL, representing many different dimensions for one entity, can all be aggregated and kept together in one database. This creates a “full picture” of what the organization knows about that entity, across all the dimensions where that the organization is tracking the entity's behavior patterns. Looking at an entity's CINEL in total, and/or seeing each of the INEL that make up that CINEL, gives a great deal of information about the entity that can be used throughout the company in interacting or creating actions for that entity. An INEL (pattern of behavior for one dimension for one entity) can be in many different entities CINEL; therefore, INEL's are not discrete by entity.

Column 3—MINEL

All the INEL from different entities, for the same dimension(s) or INEL, are combined into that INEL's Meta Individual Nano Entity Lifecycles (MINEL) which shows all the INEL patterns together for one INEL's dimensions across all entities. Combining many entities versions of the same INEL's creates a MINEL. Aggregating all the INEL's, from many entities into MINEL, allows the system and users to see how diverse or similar the behavior patterns are for different entities for the same dimension. Without this form of aggregation, this kind of review across all INEL's is not possible. The INEL's and the range of variances in the INEL's behavior patterns were not previously available at this level of detail in this type of display.

Column 4—SMINEL

A Super Meta Individual Nano Entity Lifecycle (SMINEL) is a MINEL with more than one INEL shown. In most cases an entity will have more than one INEL. Therefore being able to create classifications, or SMINEL, that allow users to consider more than one INEL is necessary, particularly since the combination of certain INEL may impact the excepted behavior of one or more of the INEL. A SMINEL, can be created with as many INEL as the user desires to combine, in order to create a grouping or analyze the differences in certain entities behavior patterns at the INEL level. This can be used when more than one dimension needs to be included so that a decision is not made based on just one dimension of an entity.

Column 5—SINEL

Similar INEL patterns of behavior, for the same dimension, from different entities, can be combined into Similar Individual Nano Entity Lifecycles (SINEL). SINEL shows all the INEL with similar behavior patterns together. SINEL are created from a MINEL. There may be several SINEL in a MINEL since within an INEL the entities can have many similar or dissimilar behavior patterns. Like a MINEL, many entities' INEL can be in a SINEL, however, unlike a MINEL, in a SINEL all the behavior patterns in the INEL are similar, as defined by using analytics. SINEL can be created with different “tightness” standards (standard deviations, etc.) so there could be one SINEL or five SINEL created from a MINEL depending on the goal or way the SINEL is planned to be used.

Column 6—SSINEL

A Super Similar Individual Nano Entity Lifecycle (SSINEL) is a SINEL with more than one INEL, with similar behavior patterns. SSINEL are created from a SMINEL, which can be created with as many INEL as the user desires to combine, in order to create a grouping or analyze the differences in their behavior patterns at the INEL level. This can be used when more than one dimension needs to be included so that a decision is not made based on just one dimension of an entity, however, the INEL to be used need to have similar behavior patterns.

Column 7—BINEL

When SINEL are aggregated and their similar behavior patterns are analyzed; their benchmark (average, mean, standard deviation, etc.) behavior pattern is used to create Benchmark Individual Entity Lifecycles (BINEL). BINEL represent the “benchmark, baseline or average, etc.” behavior of this collection of INEL, that form a SINEL, with the deviation probabilities and similar “fit” standards calculated and falling within a defined range of deviation. BINEL are a very important concept and calculation in INEL, and are used to track and predict the behavior of other entities' INEL's. BINEL can be created with different “tightness” standards (standard deviations) so there could be one BINEL or five BINEL created from a SINEL.

Column 9—SBINEL

A Super Benchmark Individual Nano Entity Lifecycle (SBINEL) is a BINEL with more than one entity and more than one dimension. It is created from a SSINEL, which is made up of numerous entities with similar behavior patterns, which was created from a SMINEL, which can be created with as many INEL as the user desires to combine, in order to create a grouping or analyze the differences in their behavior patterns at the INEL level. This can be used when more than one dimension or INEL needs to be included so that a decision is not made based on just one dimension of an entity. Numerous SBINEL can be created from a SMINEL and even from a SSINEL since while all the INEL might be very similar, there still could be two or more distinct benchmark patterns in their behaviors depending on the “tightness” of the fit that is used in the calculations.

Both traditional predictive lifecycle analytics, and this new form of predicative lifecycle analytics, that is based on BINEL and SBINEL, can be used, separately or in combination, at the INEL levels, to predict an entity's future lifecycles, values and other behavior pattern characteristics. Details on how BINEL and SBINEL are used to predict the future behavior patterns of INEL are given later. For now it is enough to understand that within a SINEL/SBINEL, and/or SSINEL, the INEL process uses the BINEL/SBINEL and its known deviations, and the past deviations of the entity from the entities historical INEL's BINEL/SBINEL, to calculate and predict the future behavior patterns of the entity's INEL. This is for along the future expected patterns in the observation periods in the BINEL/SBINEL.

This entity hierarchy classification and category process, and its information, is used to interact with each entity, at each of these levels of their interaction with each dimension. This is done to create the right prices and/or services and/or actions for that entity at that level, as needed to achieve the desired KPI(s), given their past and/or future predicted value to the organization and their expected actions and behavioral patterns. Numerous BINEL/SBINEL can be created from a MINEL and even from a SINEL/SSINEL since while all the INEL might be similar there still could be two or more distinct benchmark patterns in their behaviors. The number of categories that can be created relies on the level or tightness of the scope or filter used in defining SINEL, SSINEL, BINEL or SBINEL.

There can be past, current, future and total INEL, CINEL, MINEL, SMINEL, SINEL, SSINEL, BINEL and SBINEL. There are 8 classifications of INEL (described in FIG. 23) and 4 time frames, therefore, there are at least 32 different possible classifications to use. Other classifications can be created as needed. These are different classification of entities who share either past, present and/or future lifecycle similarities. Now we can segment, based on exact similarities that span multiple dimensions and parameters, including time, and target “groups” who will all share, have shared, or will share enough traits that we can truly focus in on a “group” as if it was an individual. Wherever INEL, CINEL, MINEL, SMINEL, SINEL, SSINEL, BINEL and SBINEL are used in this description, it should be understood that the past, current and total designations of those applications are being described, as appropriate to their settings in the explanation.

Individual Nano Entity Lifecycle Market Analysis (INELMA) is the art and science of using individual nano entity lifecycles to learn more about the market and trends in the market.

In the present invention, the fact that behavior is being broken down to an individual nano entity level, by dimension of action/interaction, by time periods (in other words the level of individual actions along individual dimensions in the past, present or future) allows a much finer and more detailed basis for understanding what is happening in the market. INEL's track behavior at the individual and single dimension of action/interaction level. This means that changes in behavior patterns can be seen much earlier when individuals start making those changes at the level of individual actions within individual dimensions.

The ability to identify the behavior of a market at its smallest level, by time frame, by the individual decisions along individual dimensions to create individual actions, allows the analyst to understand the very root of changes. It is similar to a scientist being able to see things as an atomic or molecular level, which enables the scientist to understand when something is beginning to change, why it is changing and how it is changing—as it changes and not just after the changes. The use of individual nano entity lifecycles enables this level of understanding, analytics and observation for the market. It should also be remembered that in this case we are not just speaking about customers; we are speaking about any entity that interacts or has actions with the organization. Therefore, the way that individual nano entity lifecycles are calculated opens the door for a level of market understanding at the entity level(s) which has never been obtained before.

Nano entity economics (NEE) is the application of economics that uses INEL, CINEL, MINEL, SMINEL, SINEL, SSINEL, BINEL and SBINEL to track the behavioral patterns of individual entities and uses predictive analytics to understand their future expected actions. This entity level analysis, tracking, and predictive analytics is then included in a C³ISI that combines, assimilates, and controls all of the areas that are affecting entities on both the demand, the supply, and in the enterprise levels to assure the proper alignment to achieve any targeted goal(s).

The present invention advances those analytical tools and embodies them within a self learning system, and/or systematic approach, that automates their application and allows them to be utilized in a 24/7 environment without the need for constant user management and intervention. However, user intervention and involvement is built into the approach and the system.

In the present invention, the INEL, CINEL, MINEL, SMINEL, SINEL, SSINEL, BINEL and SBINEL are not predefined by people and then followed by a search for entities that “fit” the predefined and preconceived behavior patterns. In the invention, the behavior patterns are constantly being reanalyzed and updated based on the latest actions of the entities. Nothing is static. Each action from an entity is stored, analyzed, and it's similarities with existing behavioral patterns or deviation from existing behavioral patterns is noted and analyzed and stored. Because this is done for each entity for each of their actions across each of their behavioral patterns, once the system sees enough deviations a change in the expected behavior of other entities along the same lifecycle is processed and other entities will no longer be expected to follow the prior behavioral path. This process works best when automated to process and analyze all of these changes. However, the system must also alert users when changes are occurring so that users can step in and make decisions on how fast they accept those changes as the new behavioral pattern for an entity on that lifecycle changes or emerges and whether you try to stop or accelerate the changes. If the user decides not to take an action then the system must be able to understand when enough deviation has occurred that it will take an action on its own. If the user decides to take an action the result of that action needs to be stored so it can be used in the future.

Command, Control, Communications and Intelligence System Interface (C³ISI) is an interface and system that combines in one screen live fully functioning views of many different existing systems and applications in their own “windows”. The user can determine which systems and applications they want to view, the size of each view or window, the order of each view or window in the display, have the ability to drill down into a view or window and have it open up and be shown using the entire screen. Each view or window is a fully functioning user interface to another system or application. Users can also set up exception reporting, alarms, rules-based engines and predictive analytics to be applied as specified by the user within and among the different views/windows/systems & applications that are being shown.

### The Concepts

The concept is to not use “segments” where at all possible and deal 1 to 1, in as automated a manner as possible, with whatever entities are affecting your demand, supply, enterprise and/or any other areas within your organization. Using INEL allows users to more accurately predict many future actions, interactions, desires, reactions of the entity in the immediate (tactical), long term (strategic) and lifetime time frames, across any dimensions that the entity is likely to encounter and can be measured on, based on both their and other past entities actions. INEL therefore allows users to predict tactical, strategic and lifetime entity values as well as what products/services, frequencies, actions, interactions and apply this to entity pricing, offers, actions, reactions, etc.

Organizations can now apply this new information to true 1 to 1 decisions, based on future expectations, and not just on traditionally used past behavior patterns. INEL allows organizations to predict and interact with entities at the smallest level of detail while driving them towards their optimal value(s) with the organization. These entity level interactions are automated wherever possible to assure that they are accomplished for all possible instances and performed as soon as possible after the entity does something. This allows the organization to also assure that all interactions with entities are tailored to the exact needs of that entity and are not part of a larger market segment strategy which may not apply to this entity. Unfortunately, market segments are often constructed based on one or two common behavioral traits among many entities. However, that does not mean that these entities share similar behavioral patterns across all of their decisions. CINEL is a composite of all the individual dimensions that applied to an entity, therefore, decisions based on CINEL are not based on just one dimension.

The INEL based pricing, marketing and nano entity interaction process is developed based on the behavior of past nano entities and the observed behavior of existing nano entities. This may include data points gathered from outside the current interactions with the nano entity, like demographics, psychographics, social media sites, etc. as long as they are mathematically shown to have an impact on the definitions of lifecycles and nano entities' placement within a lifecycle. Nano entities' purchases, and all other interactions with the organization, are gathered and stored in a database, distributed databases or a CRM. Nano entity lifecycles are used to determine the paths (behaviors) that nano entities are most likely going to take in their interactions with an organization and its products Manual intervention and inputs are available at any point in this process. The result is knowing what nano entities are following lifecycles that other nano entities have followed and based upon that a number of predictive actions, at the right times, can be taken dealing with the optimal pricing, marketing, CRM, loyalty programs, et al for that nano entity, based on the expected future behavior of a nano entity.

Users can access a new command, control, communications and intelligence (C³I) system interface. Within one C³ISI screen and/or application they can see, understand, make/implement decisions, create/automate organization rules and/or complex analysis, and their resulting decisions, which control the entities, and all the factors that influence the entities, on the demand and/or the supply and/or enterprise and/or any other areas or levels of the organization. There can be a C³ISI system interface for demand and/or supply and/or total enterprise. The demand and supply interfaces can be “drill downs” of the enterprise C³ISI system interface. This can be used either with or without INEL

Optimizing at the INEL levels using demand and/or supply and/or enterprise and/or any other C³ISI's, is the first time that organizations can optimize the potential of each entity, while optimally predicting and balancing them within the demand equilibrium, the supply equilibrium, the enterprise equilibrium and any other areas or user-defined equilibriums. This is like an engine that has a sophisticated computerized spark control system where all the interactions affected by and affecting the spark are controlled and optimized in order to optimize overall engine performance. Without the INEL level of prediction, interaction and control and without the ability to monitor all of these entity interactions on the demand and/or supply and/or enterprise and/or any other levels via their own C³ISI the total affect and optimization of enterprise profits could not be attained. Accomplishing this goal requires both the INEL and the C³ISI working in a combined and orchestrated effort. This new approach to achieving the optimal equilibriums simultaneously on the demand, supply and enterprise levels is called Nano Entity Economics. Unless all of these pieces are put together the total result(s) will not be obtained, however, C³ISI for demand and/or supply and/or enterprise and/or any other and INEL can add value without the other.

Without the C³ISI management steps it is very possible that all the greatest nano entity marketing efforts will be thwarted by macro supply and demand imbalances that would result in the actions of the nano entity marketing being nullified and prevented from being realized. In order to optimize profits an organization must use nano entity predictive lifecycle analytics (NEPLA) to determine the best interactions to take with nano entities and then follow that up with multiple levels of hierarchical C³ISI systems that assures the nano entity interactions are allowed where they can fit within the larger enterprise supply/demand balance perspective.

### Creating Individual Nano Entity Lifecycles (INEL)

### 1) The Concepts of INEL and MINEL.

The INEL of an entity should not be looked at with one dimension. An INEL deals with a single dimension, parameter and/or reason to act or interact—that describes that entity's behavior along one dimension. To understand a total entity requires more than one INEL.

The behavior or INEL of an entity must be looked at as the multiple different INEL, or patterns of concurrent behavior, that an entity is creating. There can and must be many different ways of building INEL because organizations can have many different combinations of available data based on the behavior pattern that is being analyzed. Entities may also have many different behavioral patterns or trends which will each lend them to as many different forms of analysis. Therefore there needs to be different methods used to build the different INEL and there needs to be many different sources of data available to support these different needs.

A wide variety of analytical methods and all of the available data about entities will need to be used in determining the INEL of entities. Depending on the entity, that entity's behavior and the data that is available, different analysis might be necessary for analyzing the same behavior pattern for different entities. There can be no preconceived list of the types of analytics that should be used. Doing this would ignore the fact that there is and will be a never ending array of many different behavioral patterns, many different types of available data and many different types of actions. These are all changing so rapidly, based on both micro and macro stimuli, that any attempt at just using predefined analytical methods will be out of date and unable to capture all of the INEL as soon as the definitions are written. To do this makes this process not much better than using predefined and static stages and behavioral patterns of existing art. No one process or patterns can be expected to be applicable forever to any other entity's behavioral pattern. While there may be processes that can be reused, the many INEL that make up all of the behavioral patterns of an entity should each be approached initially with complete statistical analytical separation until the statistical process shows that the match the patterns of another INEL. The analytics in INEL must be continually tested, challenged, improved and new approaches discovered and then applied.

It is important to be able to identify, track and interact with EACH separate INEL that belongs to one entity. The things that can be tracked as an INEL are any attributes or actions, or other piece of internally derived or external information, whether it appears to be attached to the entity or not. These need to be proven to have statistical or mathematical value in identifying, tracking, analyzing and predicting an INEL, for the entity or entities. Entities if the SINEL of a group is being tracked where multiple entities are for some reason combining and acting or being treated as one entity. Once INEL are determined and combined into MINEL and SINEL, the process can work at both the INEL, MINEL and SINEL levels. The process of combining INEL into MINEL and then combining INEL into SINEL and then calculating BINEL must also be approached and tested as a statistically separate and objective process.

Entities are doing multiple different things along multiple different paths, and these paths (or patterns of concurrent regressions) must be captured individually and then combined for the user to see in order to understand what we conceive as THE one INEL that the entity in on. If you tried to regress all the actions of entities against the same variables, they would appear to be doing multiple different things and different patterns. You have to analyze them separately, the way they are actually occurring in the mind and actions of the entity and THEN combine them. CINEL are the nexus of all of these INEL patterns, and where they all come together, but that does not mean that you can combine ALL the actions and then try to analyze them once they are combined. It is like learning language, we need to learn and understand each word and then each thought and phrase, then each sentence and each paragraph, etc. We cannot start by tying to absorb a book without understanding the pieces that are produced to create the whole.

On the supply side, it's important to understand that the products can be created through the relationships with the entities, and do not have to be hard tangible products. They can be virtual things that can be created on-the-fly, if that is what is being requested by entities. Products need to be looked at as “what the entities on the demand side want” which can include a wide range of things that are not even necessarily tangible products, or things that can be possessed. On the demand side, entities can want certain service levels, certain recognition, certain interaction or any other type of service or recognition.

The model uses statistics/mathematics to determine the INEL. This allows INEL to be discovered that users would not suggest or expect. Users can also suggest INEL, find if people are following these created INEL, who is following them, or users can suggest variables to investigate to determine if they create INEL. The process must look through ALL the available data on the entities and the environment(s) that they were in and determine the patterns that can be used as INEL as well as what variables can be used to predict future entity behavior. It then uses statistics/mathematics to track the entities against their lifecycles and determine how closely they are following the “average” pattern(s) and then this variance, along with similar patterns and variations from prior entities that appear to be on the same path as, are used in prediction(s) of future behavior versus their expected common future behavior pattern. Statistics/math can also be used to determine the variances. This process is both automated and allows manual intervention. The longer the system is used, the more automated the system can become, assuming that the behavioral patterns do not become very erratic and hard to predict.

One of the methods that can be used in finding entity lifecycles or INEL is cluster analysis. A brief description of the standard forms of cluster analysis follows. INEL, CINEL, MINEL, SMINEL, SINEL, SSINEL, BINEL and SBINEL can use many statistical methods to find the patterns of behavior for their entities.

It should be understood that new statistical methods that will be developed can be applied to implement the invention, and that these new methods also fall within the scope of the invention. These techniques are a normal expansion of the science of statistics and mathematical modeling and are not necessarily specific to the systematic application of INEL, CINEL, MINEL, SMINEL, SINEL, SSINEL, BINEL and SBINEL. The new techniques, by themselves, would not give the results that are sought after or obtainable through the INEL, CINEL, MINEL, SMINEL, SINEL, SSINEL, BINEL and SBINEL processes. The invention is not necessarily about an individual technique at finding patterns. The invention is about an approach to finding and using and leveraging the predictive capabilities of these patterns within a system that seeks the optimal equilibrium for total demand optimization, total supply optimization and finally total enterprise optimization.

The following information on a method called statistical clustering is offered to show some of the statistical methods and tools that exist to build INEL. Other and newer methods may exist, however they will all fit within the INEL, CINEL, MINEL, SMINEL, SINEL, SSINEL, BINEL and SBINEL framework, system and process.

The following information on Cluster analysis was obtained from Wikipedia.

“Cluster analysis’ is a class of statistical techniques that can be applied to data that exhibit “natural” groupings. Cluster analysis sorts through the raw data and groups them into clusters. A cluster is a group of relatively homogeneous cases or observations. Objects in a cluster are similar to each other. They are also dissimilar to objects outside the cluster, particularly objects in other clusters.

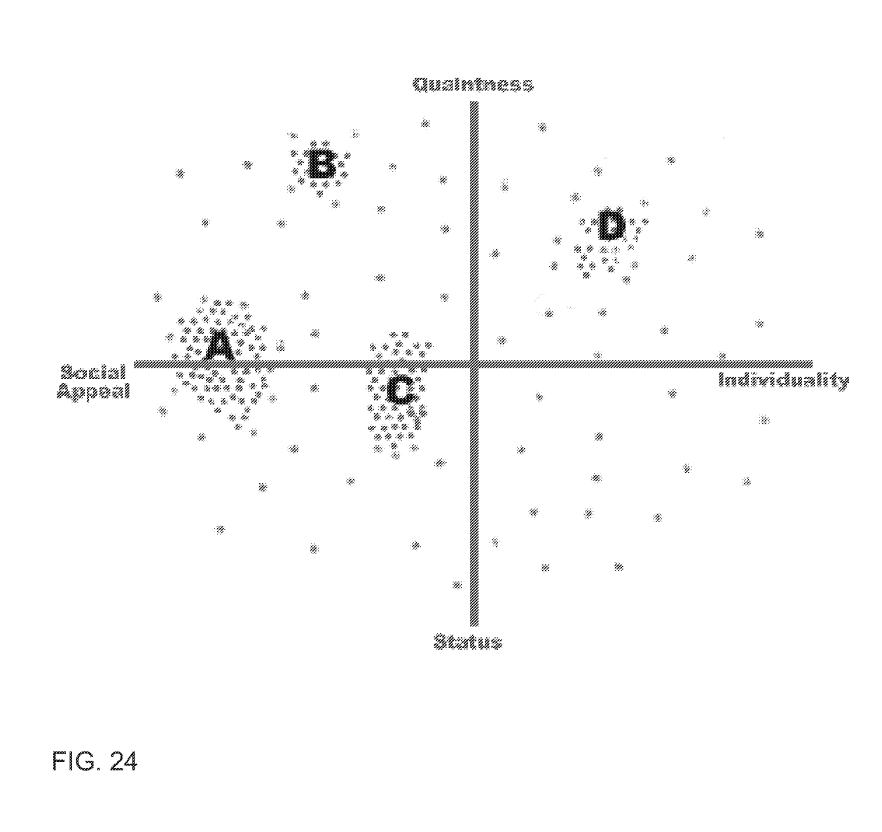

FIG. 24 illustrates the results of a survey that studied drinkers' perceptions of spirits (alcohol). Each point represents the results from one respondent. The research indicates there are four clusters in this market.

Another example is the vacation travel market. Recent research has identified three clusters or market segments. They are the: 1) The demanders—they want exceptional service and expect to be pampered; 2) The escapists—they want to get away and just relax; 3) The educationalist—they want to see new things, go to museums, go on a safari, or experience new cultures.

Cluster analysis, like factor analysis and multi dimensional scaling, is an interdependence technique: it makes no distinction between dependent and independent variables. The entire set of interdependent relationships is examined. It is similar to multi dimensional scaling in that both examine inter-object similarity by examining the complete set of interdependent relationships. The difference is that multi dimensional scaling identifies underlying dimensions, while cluster analysis identifies clusters. Cluster analysis is the obverse of factor analysis. Whereas factor analysis reduces the number of variables by grouping them into a smaller set of factors, cluster analysis reduces the number of observations or cases by grouping them into a smaller set of clusters.

In marketing, cluster analysis is used for: 1) segmenting the market and determining target markets, 2) product positioning and New Product Development, 3) selecting test markets (see: experimental techniques)

### Basic Procedure

1) Formulate the problem—select the variables that you wish to apply the clustering technique to, 2) Select a distance measure—various ways of computing distance: a) Squared Euclidean distance—the square root of the sum of the squared differences in value for each variable, b) Manhattan distance—the sum of the absolute differences in value for any variable. c) Chebyshev distance—the maximum absolute difference in values for any variable, d) Mahalanobis (or correlation) distance—this measure uses the correlation coefficients between the observations and uses that as a measure to cluster them. This is an important measure since it is unit invariant (can literally compare apples to oranges).

Then—1) select a clustering procedure (see below), 2) decide on the number of clusters, 3) Map and interpret clusters—draw conclusions—illustrative techniques like perceptual maps, icicle plots, and dendrograms are useful, 4) Assess reliability and validity—various methods, 5) repeat analysis but use different distance measure, 6) repeat analysis but use different clustering technique, 7) split the data randomly into two halves and analyze each part separately, 8) repeat analysis several times, deleting one variable each time, 9) repeat analysis several times, using a different order each time,

Clustering Procedures

There are several types of clustering methods: 1) Non-Hierarchical clustering (also called k-means clustering), a) first determine a cluster center, then group all objects that are within a certain distance.

Examples: 1) Sequential Threshold method—first determine a cluster center, then group all objects that are within a predetermined threshold from the center—one cluster is created at a time, 2) Parallel Threshold method—simultaneously several cluster centers are determined, then objects that are within a predetermined threshold from the centers are grouped, 3) Optimizing Partitioning method—first a non-hierarchical procedure is run, then objects are reassigned so as to optimize an overall criterion, 4) Hierarchical clustering—objects are organized into an hierarchical structure as part of the procedure, 5) Divisive clustering—start by treating all objects as if they are part of a single large cluster, then divide the cluster into smaller and smaller clusters, 6) Agglomerative clustering—start by treating each object as a separate cluster, then group them into bigger and bigger clusters.

Examples: 1) Centroid methods—clusters are generated that maximize the distance between the centers of clusters (a centroid is the mean value for all the objects in the cluster), 2) Variance methods—clusters are generated that minimize the within-cluster variance a) Ward's Procedure—clusters are generated that minimize the squared Euclidean distance to the center mean, b) Linkage methods—cluster objects based on the distance between them i) Single Linkage method—cluster objects based on the minimum distance between them (also called the nearest neighbor rule), ii) Complete Linkage method—cluster objects based on the maximum distance between them (also called the furthest neighbor rule), iii) Average Linkage method—cluster objects based on the average distance between all pairs of objects (one member of the pair must be from a different cluster)” The Journal of Classification. Is a publication of the Classification Society of North America that specializes on the mathematical and statistical theory of cluster analysis and is a good reference on the mathematical methods to use.

Another way to build an INEL is to look at the last action of an entity and based on historical data look at the probabilities of what the next action will be along the same dimension for that entity. The predicted confidence interval or deviations within the observed patterns can be noted. Then that same method can be used for what the next likely action or reaction would be by that entity for their second behavioral pattern point, given their prior history and also give the behavior point that was just predicted before the second behavioral point. This can be refined based on not only what their last action was but with their last two actions were. In this way, numerous observations and probabilities can be defined, and calculated based on each other in a forward progressing strain of predictive analytical actions, and then accumulated into an array or path or pattern which is most probable, with the associated uncertainties provided.

The goal of this invention is not to simply define one probability for one future action and the goal is not to just define one behavioral pattern or path of probabilities. People's interactions and actions are defined across many different dimensions and many different behavioral patterns which need to then be aggregated. People are complex and not simple and linear.

Information to be used in INEL can come from any internal or external sources that have information that proves effective in working with INEL. The data should come from all areas that impact the INEL. Social media, economics news, wars, online, financial status, demographics, psychographics, macro economics, etc. can all be used with other internal variables to produce and use INEL. Different people can be on essentially the same INEL and be influenced by these and other factors to alter their INEL paths. All similar INEL's do not have to and will not use the exact same data or even predictive analytics tools. The methodology in the data can be unique to the individual and the nano entity lifecycle that they are on.

Find and use anything that helps analytically in using INEL. As things (entities, INEL, environments, etc) change so will the observations and/or variables that can be used to understand these changes. If a new approach to economics and business is to rely on INEL of entities, then everything possible must be continually tested and used if they add value to the understanding and use of INEL at the entity or entities level(s). This is part of the reason an automated 24/7 systematic approach is suggested.

However, these tools could also be used manually in a batch process until the system is sophisticated enough to run on its own. An automated system that has individual tools and models that can also be used manually. The process assists by finding things that you would not know or expect and show them to you. Whatever methods or data are used to define the INEL it is very important that all of these different methods and data sources are then combined to assist in determining the most probable INEL and/or path that the entity will follow in the future.

A program that looks at the probability of an entity or someone doing something else in the future loses part of the power of its observation because those are finite separate observations. With INEL you are tracking what you expected to happen what did happen at a very individual level and understanding what percentage and which of your entities actions did not track the way you expected them to. This automated feedback loop allows these observations to then be automatically applied to future predictions for the INEL of specific entities.

The system described herein can deal with stray probabilities. In the prior art the probabilities were generally applied to groups of people instead of individual people. The same level of learning and impact on future predictions cannot be attained by simple probabilities that are applied to groups of people. Probabilities are discrete and apply to that one occurrence. Probabilities are not cumulative and future probabilities are not as heavily impacted by current probabilities as a future INEL is impacted by a current INEL. Probabilities need to be investigated at the individual entities level and then accumulated and should not be first investigated at the aggregated or segment levels.

The goal of the nano entity INEL is to understand the full journey of an entity through their relationship with you and their behavior. You want to understand this point by point, but you want to understand all of these points and error rates over time so that you can see the entire journey and understand your interaction both in the past and through the future.

INEL can be used anyplace that there is a behavioral pattern within an entity. The power of the INEL approach is that you're breaking the pattern apart into INEL at the past, present, future and entire lifecycle levels and then putting them back together into CINEL, MINEL, SMINEL, SINEL, SSINEL, BINEL, and SBINEL. There are many different patterns and the best way to identify these is going to be to understand and track them individually and then accumulate them instead of trying to find some analytical way to understand them once they're accumulated.

One of the best ways to improve the accuracy of a forecasting model is to break down the segment that was being forecasted into smaller segments of individuals who were acting similarly because they were getting similar marketing messages and stimulations. By breaking down the group and dealing with it at the level of the smallest common denominator, it becomes possible to increase the forecasting accuracy dramatically. Those portions of the group being forecast that were either too small to statistically support their own forecast model, or were too diverse and unpredictable to be forecasted, are lumped together into one segment. This allows one to get very good forecasts on all of the other segments, and then look at the remaining demand segment that was hard to forecast and manually try to assess that and then combine all of these forecasts together. Similarly, the INEL analytics software has to break behavior down to its lowest level where there is predictability and try to develop that predictability before rolling each of the dimensions within the INEL up into a CINEL, MINEL, SMINEL, SINEL, SSINEL, BINEL, and SBINEL. Where there are patterns the system will have predictable behavior within an acceptable range of deviation, the other areas are where human intervention will need to occur. The system will need to identify those and present them to the users with all of the analysis and that data are available and let the users determine what needs to be done. This approach allows you to determine and to plan their behavior patterns, which have predictability, and to find those at their lowest levels. Then the areas which have questionable predictability can still be modeled but they can be kept isolated from the areas that have predictability so that they do not interfere with the predictability of those areas which can be properly modeled.

INEL may not occur in a linear fashion. All of the actions of entities may not plot out along an X axis timeline into neat patterns. The multiple INEL that make up CINEL, MINEL, SMINEL, SINEL, SSINEL, BINEL, and SBINEL may have behavioral actions or occurrences that overlap each other, or that are separated from each other, along the X axis that is a representation of time.

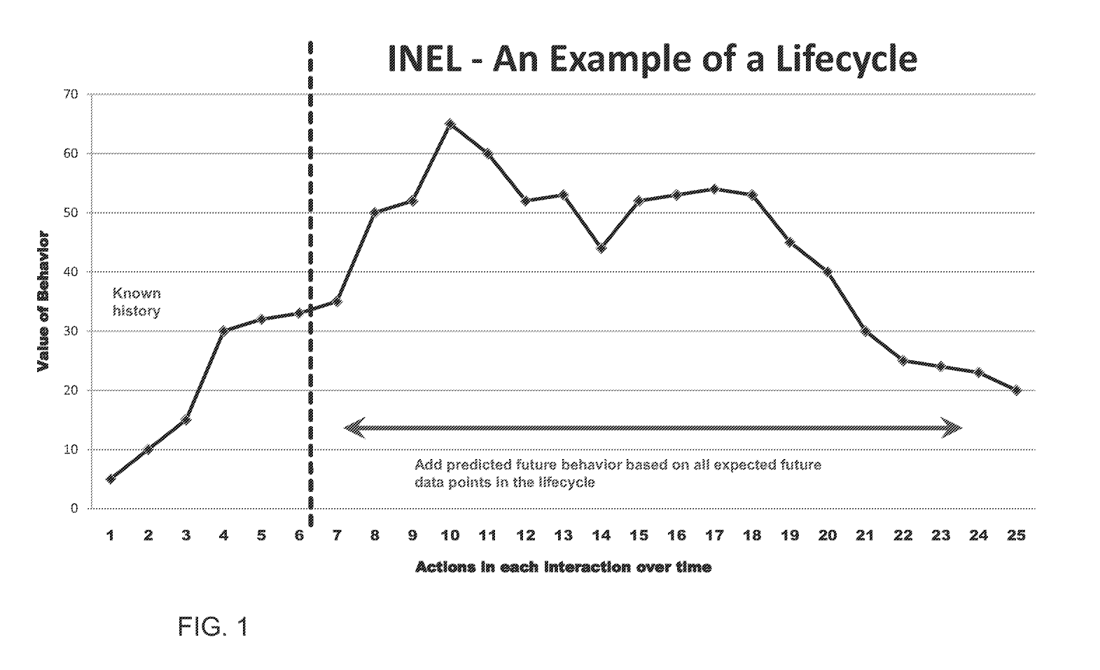

FIG. 1 gives an example of an INEL. It shows the many different interactions that will occur in the lifetime of the INEL. The dotted red vertical line shows all of the actions which have already happened, to the left of that line, and all of the predicted future actions to the right side of that line.

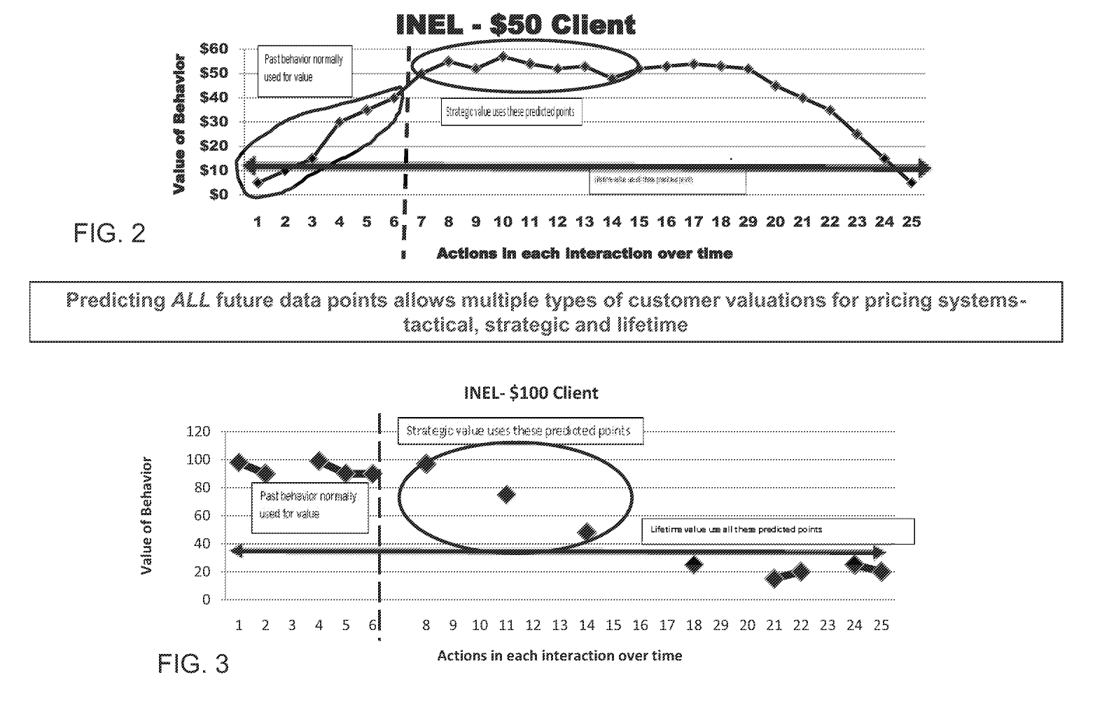

FIG. 2 and FIG. 3, which are both on the same page, give examples of two different entities. You can see that under normal entity valuation the hundred dollars per interaction client would be predicted to have more future value (assuming the same red dotted line, immediately after interaction number six on the x-axis, showing which observations are passed and which ones are predicted). If we were to see the full future lifecycles of entities it would be clear that the $50 per past interaction client has a far greater future value to the organization that the $100 per past interaction client.

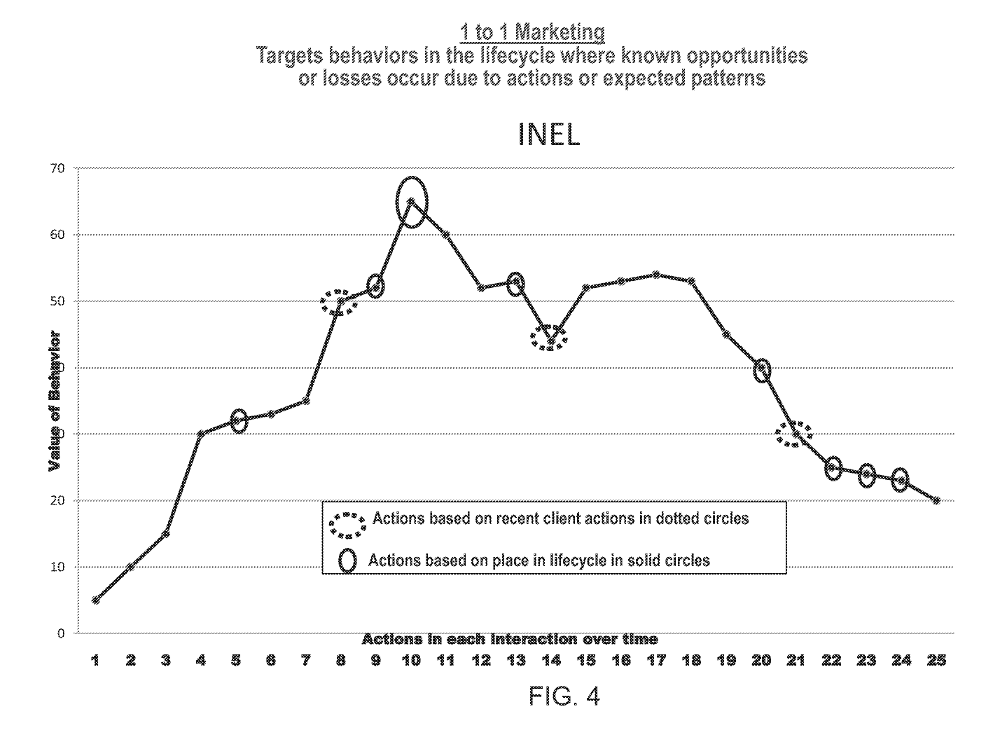

FIG. 4 shows a lifecycle for an entity and the different types of actions by the entity which created a reaction by the organization based on lifecycles. There are actions undertaken as a reaction to what the entity has done, these are circled with broken lines, and there are actions taken by the organization which are due to where the entity is on the lifecycle, these are circled in solid lines.

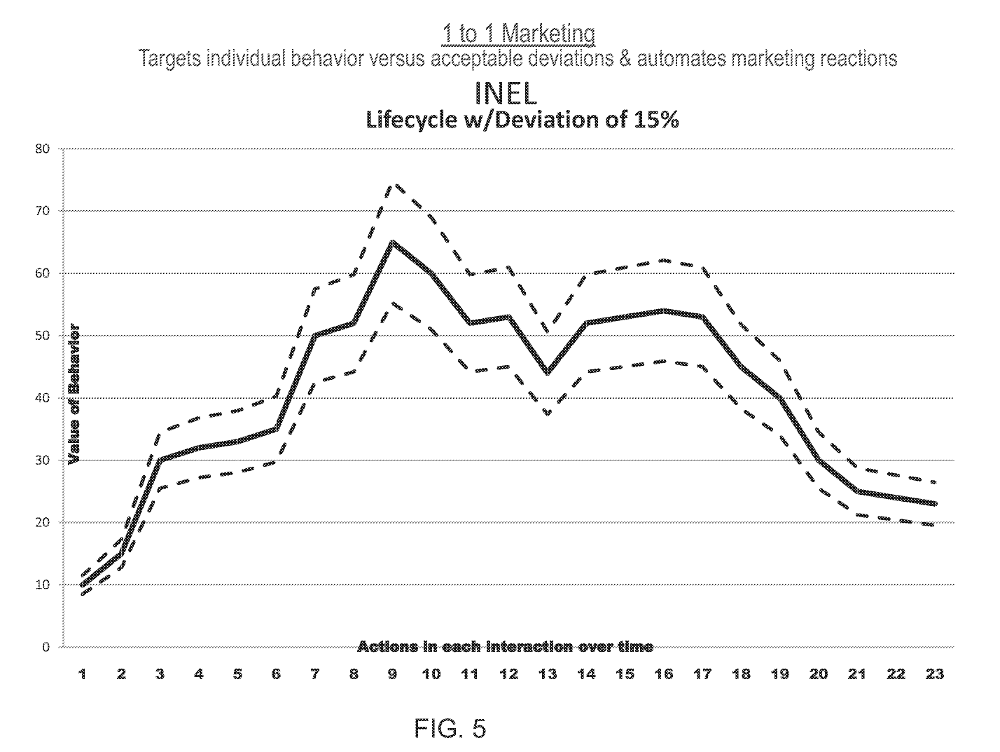

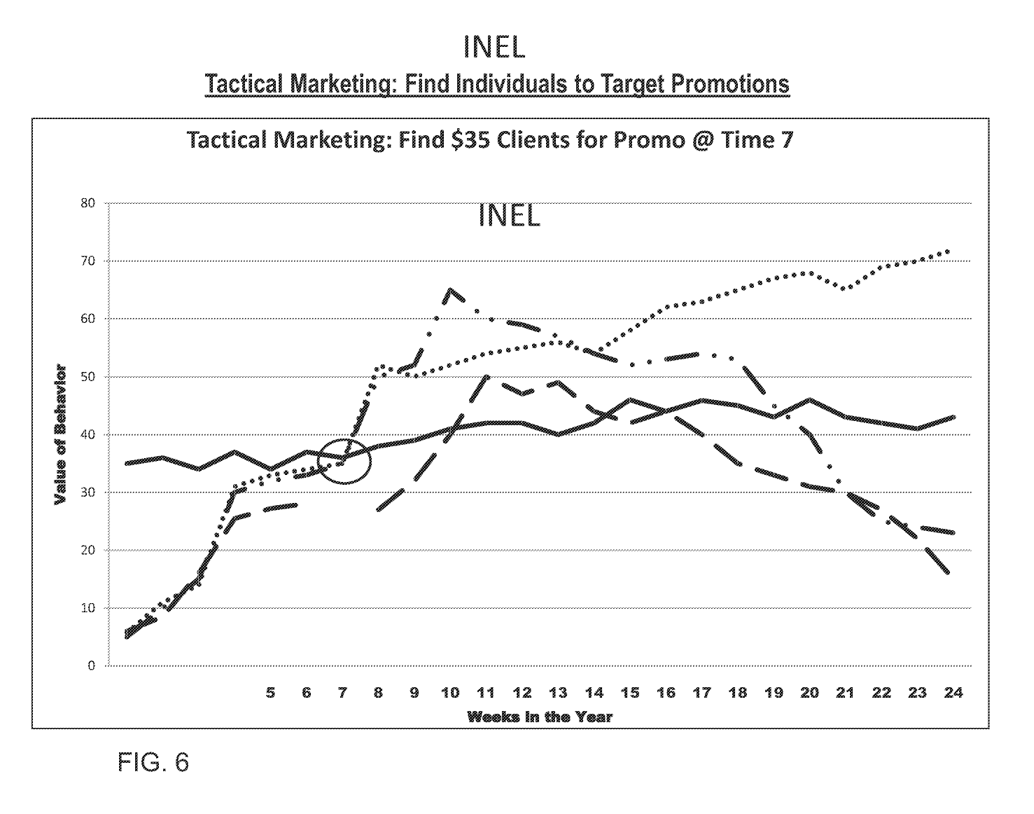

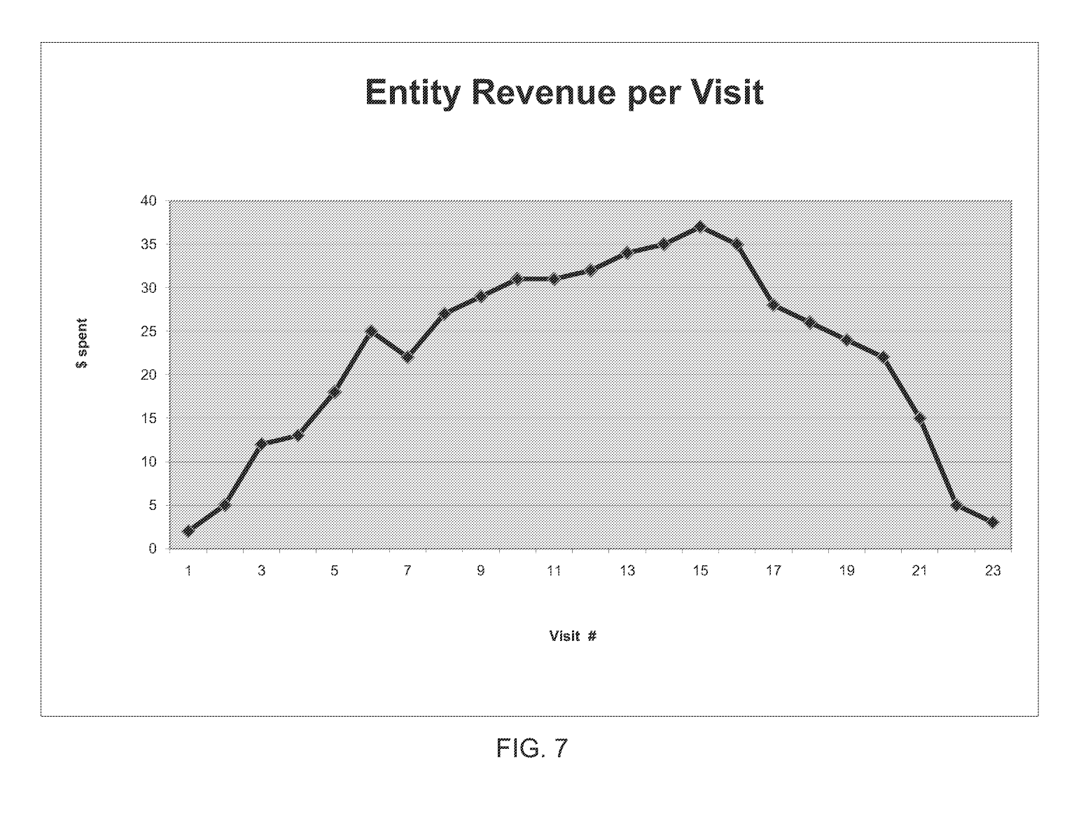

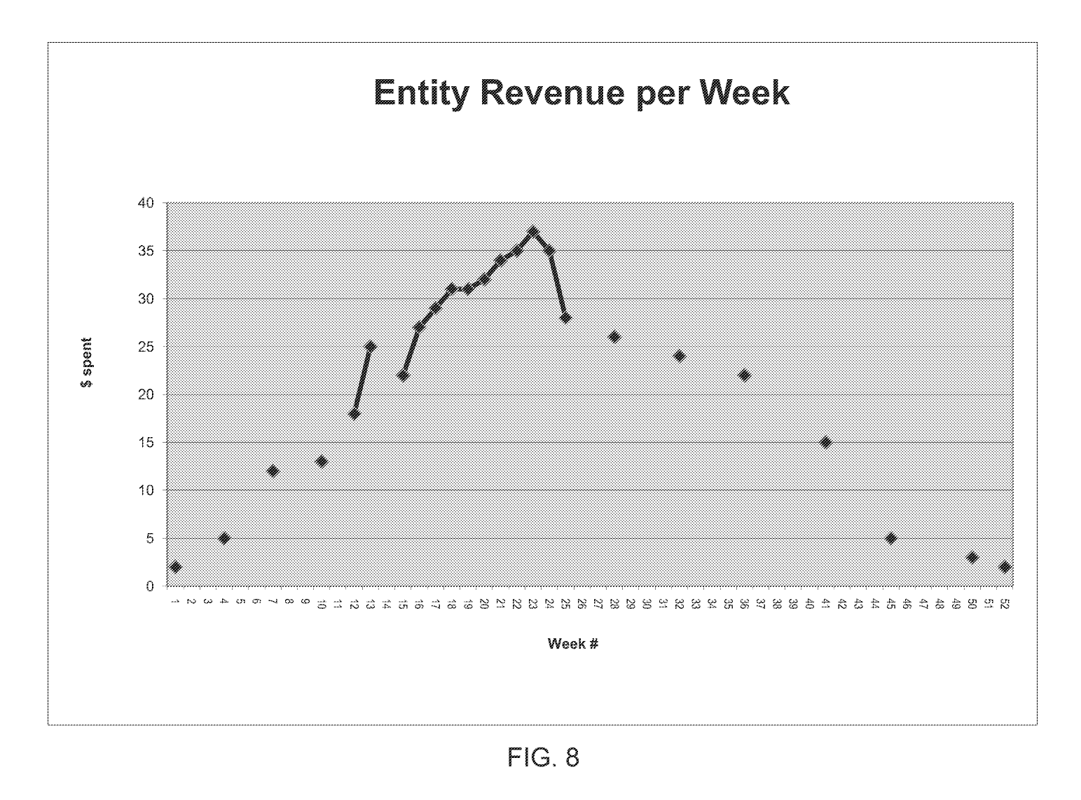

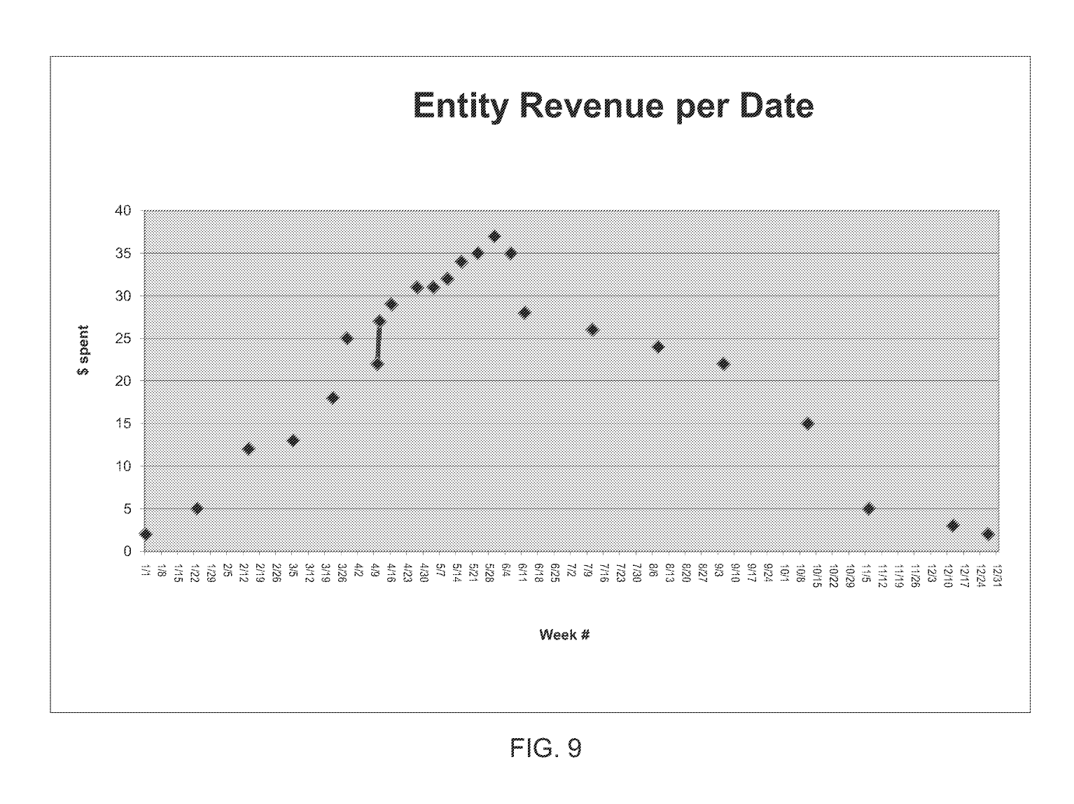

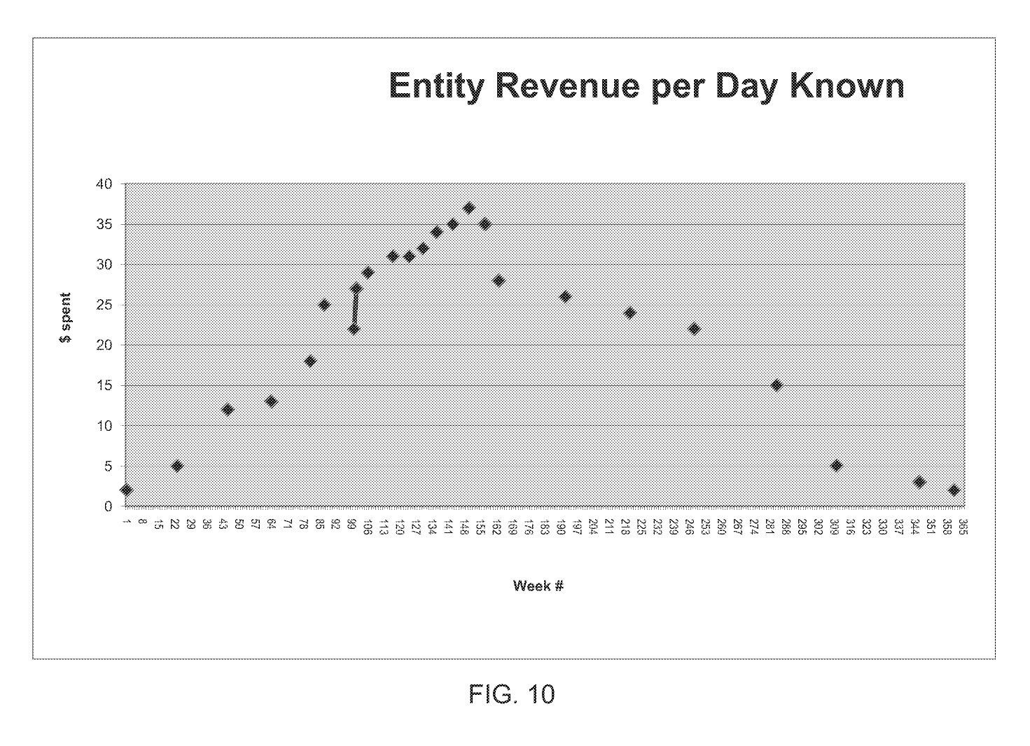

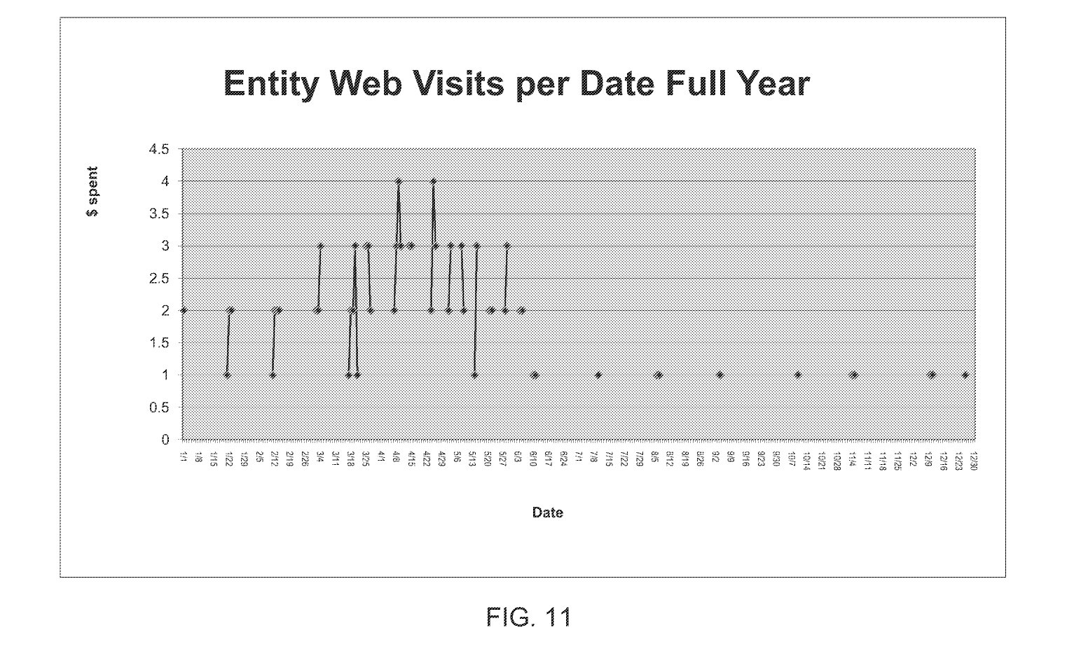

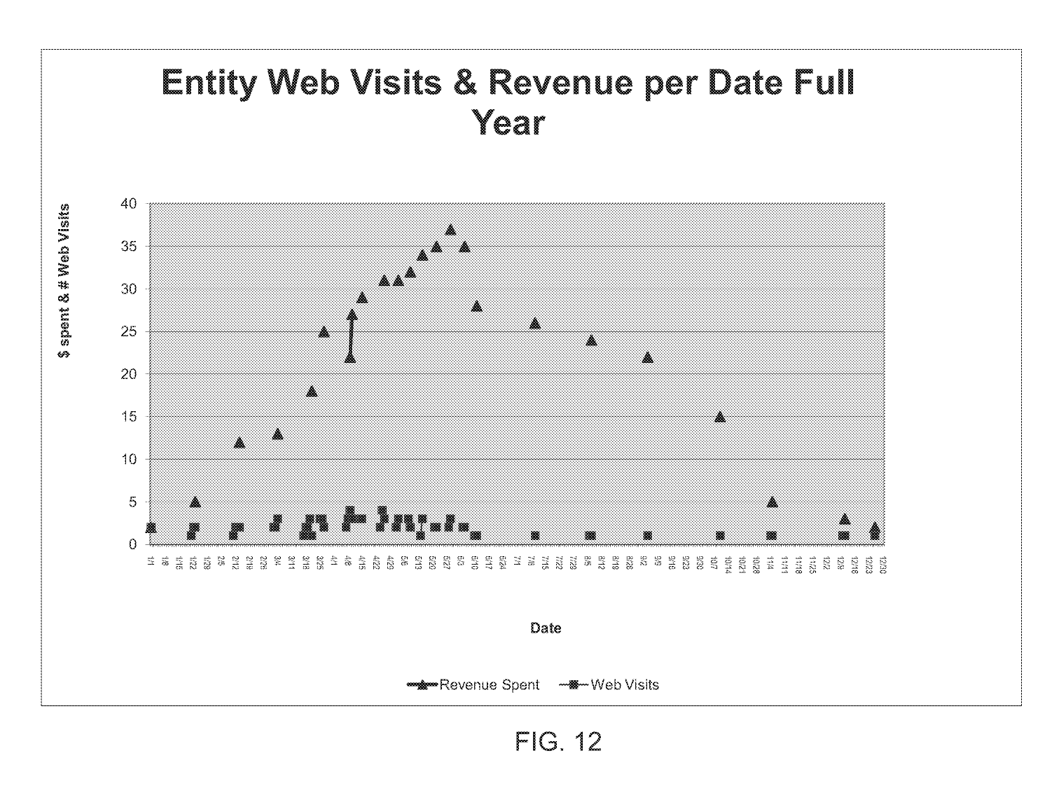

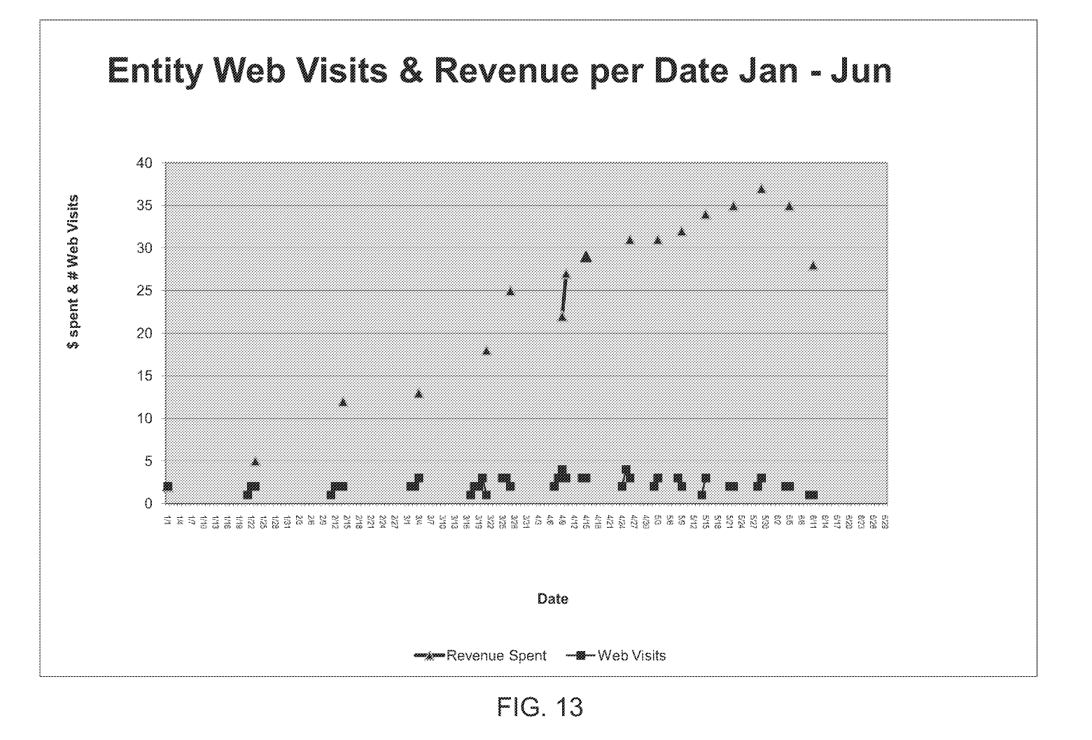

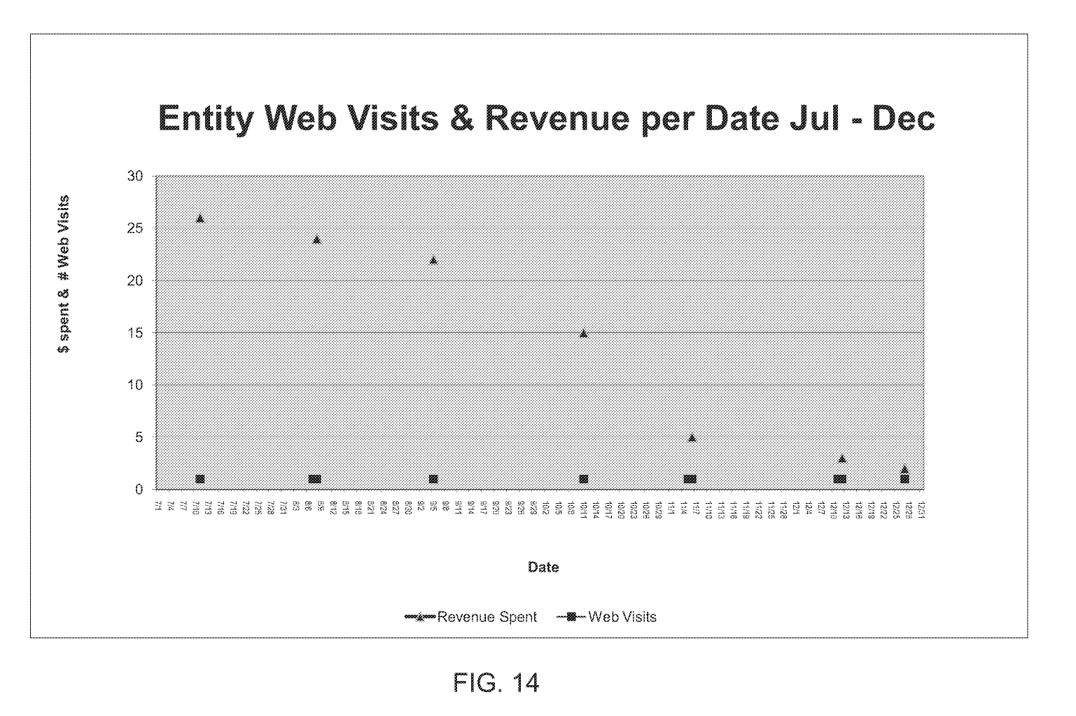

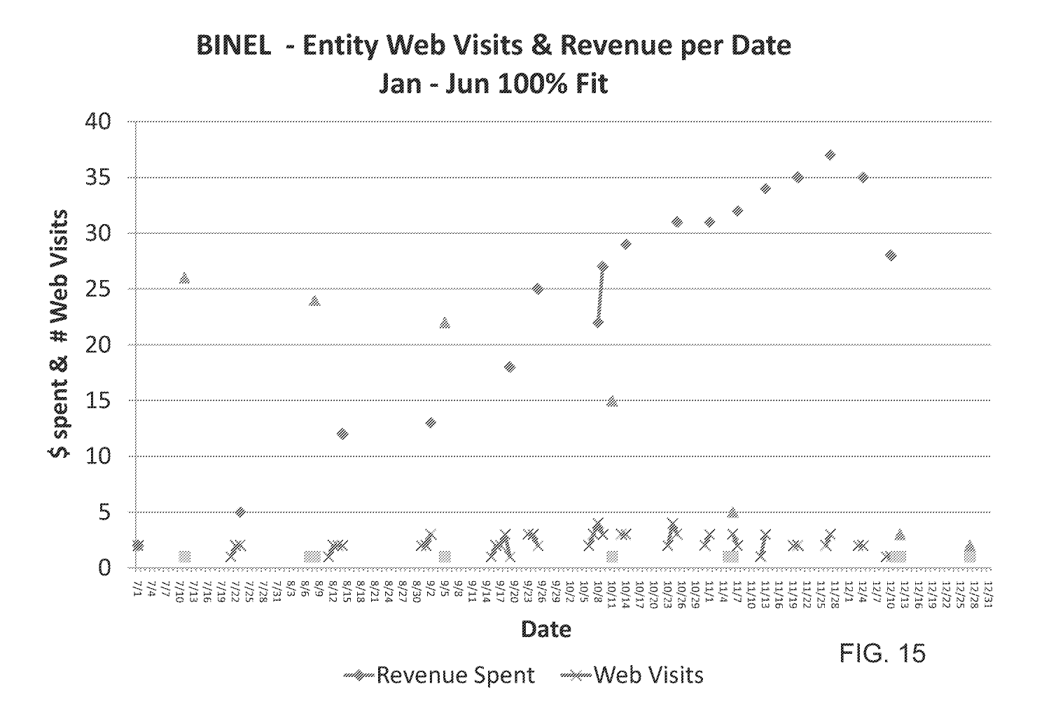

FIG. 5 shows an example of a predicted lifecycle and a 15% deviation parameter based around that predicted lifecycle. FIG. 6 shows how INEL can be used to target entities for promotion. In this example we are looking for entities whose natural actions are to be willing to make a $35 purchase at around time period seven. FIGS. 7 through 11 show different ways that INEL can be graphically displayed. The difference here is what is on the x-axis and how they spend is being calculated and shown. FIG. 11 shows the number of visits the entity made the organization website on each date. FIGS. 12, 13 and 14 show CINEL which is the combined level of an entity. In this case the entity has a history for money spent per date and website visits per date. These are both shown on one graph using different variables for the x-axis. FIG. 15 shows a BINEL, which is a combination of INEL for different entities which all have similar INEL behavior. In this case the benchmark is a 100% fit.

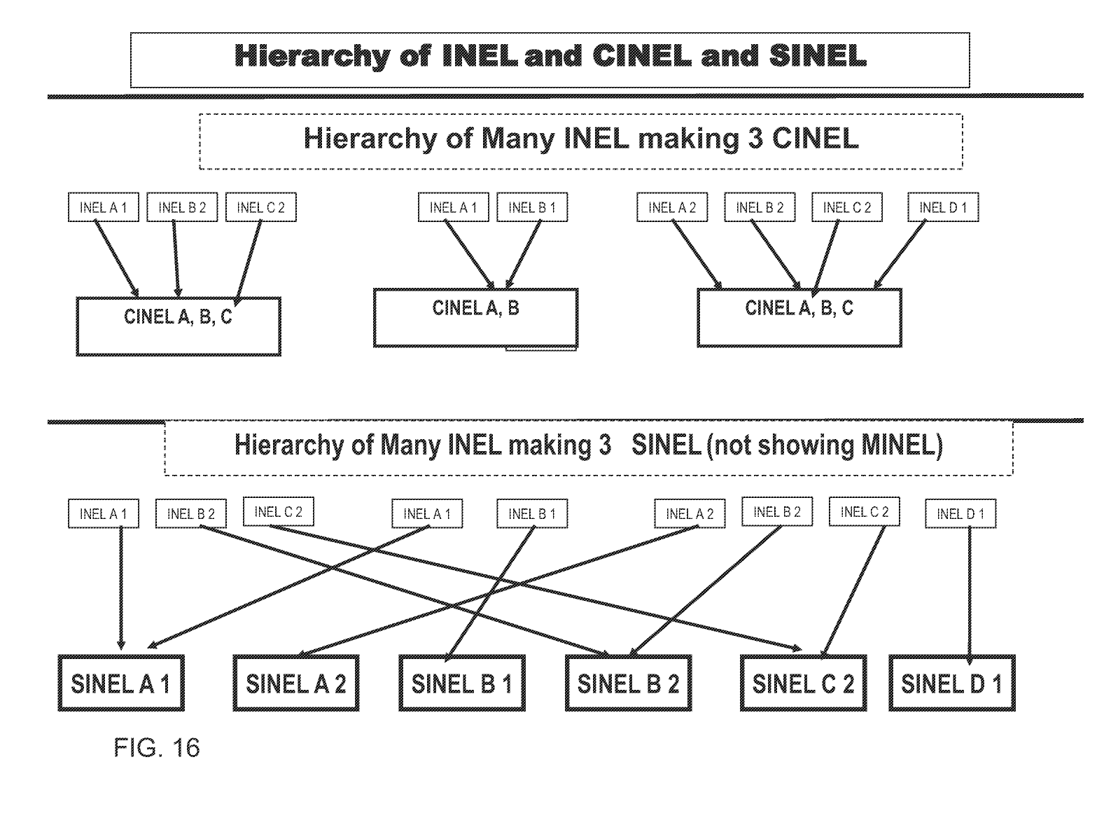

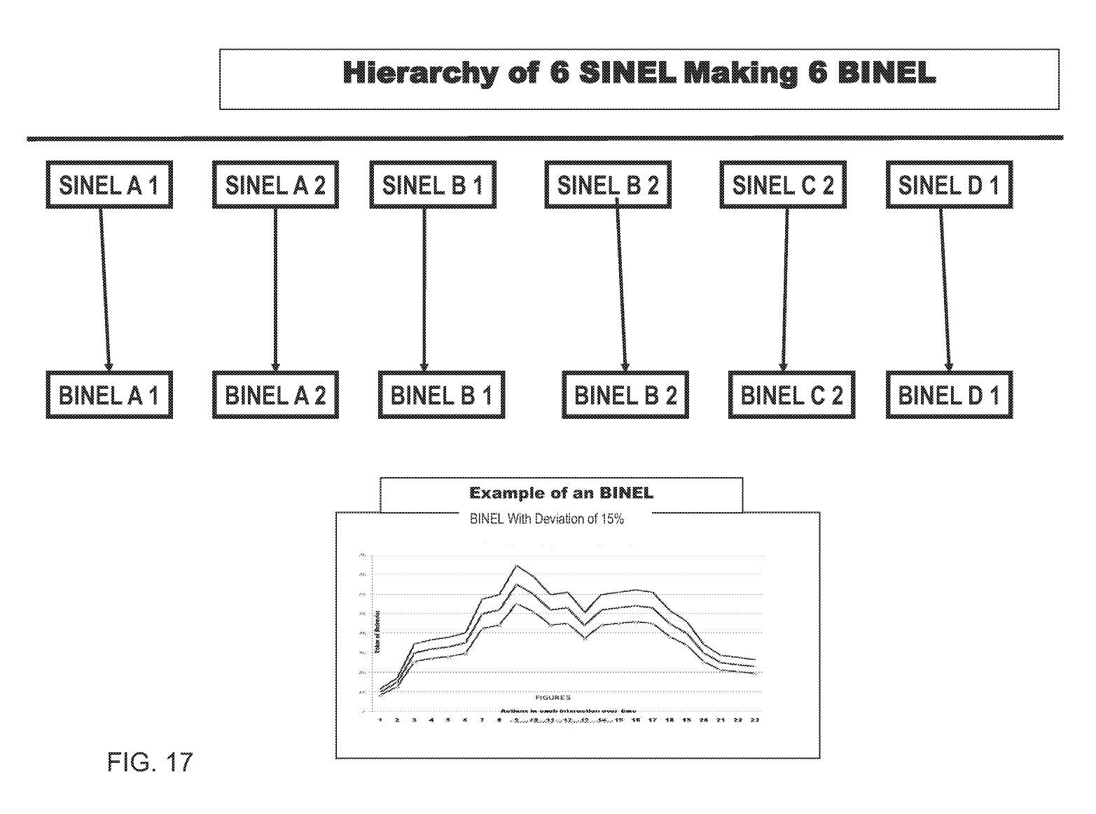

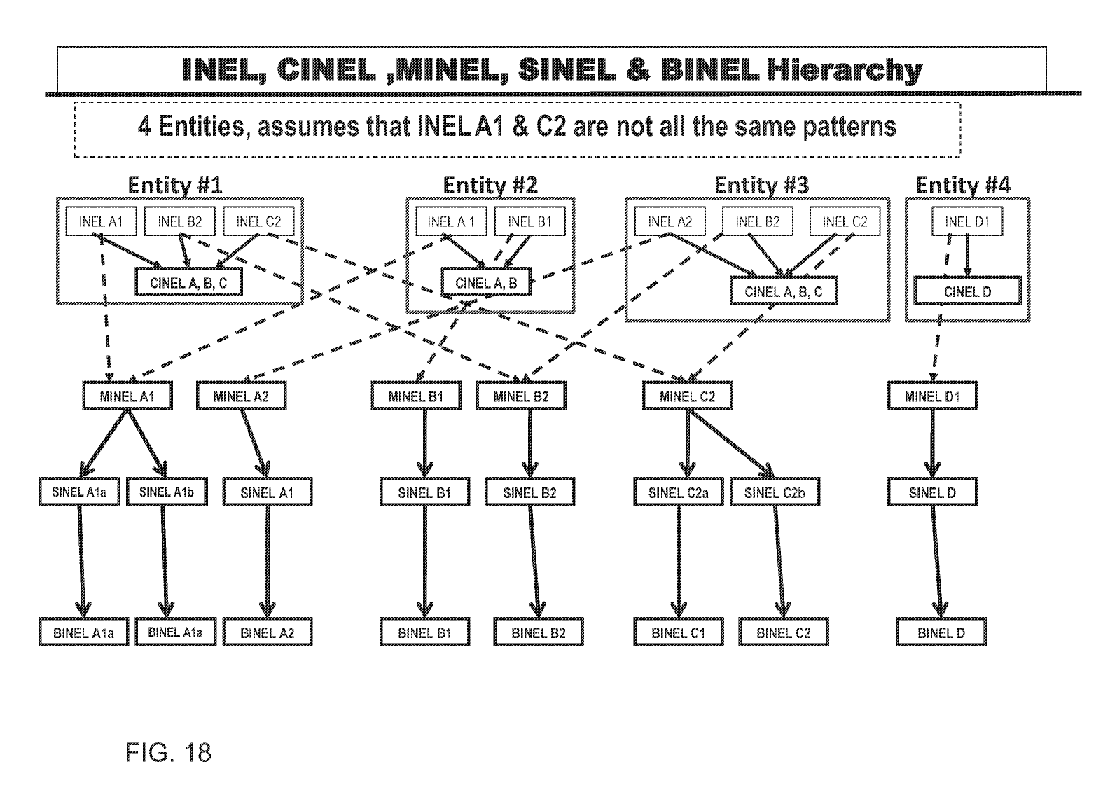

FIG. 16 shows the hierarchy of the INEL, CINEL and SINEL patterns. The super combined, meta and super meta and super similar and super benchmark classifications are not shown. FIG. 17 shows how similar INEL or SINEL, are used to create benchmark INEL, or BINEL. An example of a benchmark INEL is also shown. FIG. 18 shows the hierarchy of the individual, combined, meta-, similar and benchmark INEL. The diagram shows how for different entities with a different mixture of INEL can be used to create compound, meta, similar and benchmark INEL. FIG. 23 is a table that shows the hierarchy's and makeup of the different levels of INEL.

### 2) Using CINEL, MINEL, SINEL and BINEL

This section will speak about some of the applications of INEL so the reader and potential users will understand the possibilities with this new approach and set of tools. What is the goal of marketing automation? According to a company called Relationship One, “Marketing automation really has one universal goal—to optimize the effectiveness of your marketing budget and staff. Whether your focus is delivering qualified leads to your sales team, building ongoing lead nurturing programs, reporting on multi-channel campaign.” Marketing is the art and science of managing and optimizing an organization's relationships with its customers. In this case, we will extend that relationship to include all entities, and not just customers. This is because many entities that are not direct entities can have a large impact on the organization and the perception by its entities of the value and products that the organization offers.

The INEL hierarchy is not in and of itself a revenue management system, a dynamic pricing system, a CRM, or a marketing automation system. INEL and the C³ISI which we will speak about later, are instead a process and system which allows you to better understand many aspects of your customers, or entities, including their value (present tactical value, longer-term strategic value, and lifetime value), what they want, when they want it, but they do not want, how to influence them to do things that you wanted them to do, and how you can influence them to not do things that you do not want them to do. INEL analyzes, tracks, and predicts how entities will react to actions. With that understanding, and quantitative calculations and values associated with those understandings, INEL can become a very key component that supplies vital entity data and predictions to your revenue management, dynamic pricing, CRM or marketing automation strategy and systems. The C³ISI, which we will talk about later, will interact and display all of the other systems in the organization that affects the behavioral patterns of entities. However, here again, the C³ISI does not replace those systems.

In effect, C³ISI is the glue that can be used to bind all of the other systems in an organization together and allow them to be accessed and coordinated from one interface (this will be described in further detail later.) The INEL, CINEL, MINEL, SMINEL, SINEL, SSINEL, BINEL and SBINEL component allows an understanding, analysis, and tracking of the smallest entities that interact with an organization. In some ways these two new components act as the bread and the condiments that create the sandwich which uses the existing systems and applications in an organization as the meat and cheese. If both the bread and the condiments are not available to add to the meat and cheese you do not have a complete sandwich that is made the way it needs to be consumed.

The predictive power of the INEL is that the future anticipated path along an INEL can be quantified and displayed to the user(s) as a BINEL or a SBINEL. The probability of following that INEL can be refined given the past history of how closely the entity followed what was expected for past INEL occurrences. This can be done at the individual INEL levels as well as at the other levels. If there are not many past data points, the predictions of future INEL behavior(s) can utilize more of the standard INEL pattern. If there are more observations the models can look at the variances in the past between the standard INEL and the observed behavior(s) and utilize that as a factor to blend into the future predictions. The accuracy and specificity of predictions to an entity are therefore emerging—they get better as more observations are gathered. The predictions, and as one example the blending of past variances and future predictions, can be automatically or manually weighted to determine how aggressive and individual and how “routine” or average the predictions will be and what inputs and their weightings will be used in the predictions. You can force a “blend” or allow an automatic blend. You can force an aggressive prediction pattern and then act from that prediction if you want to be very aggressive in your interactions, actions, etc. You can dial this up or dial it down as desired for the sake of interactions or loyalty factors. You can dial up or down the positive or the negative factors and not have to dial it all up or down.

INEL is an automated system, but its tools and models can be used manually. However the need for the process comes from the fact that you don't know what you're looking for in the system and using the mathematics and statistics in an automated fashion allows you to find these INEL patterns that you are looking for. Without the automation this would not be possible. The automated system then tracks those patterns looks for changes in those patterns and notices when individuals are not acting within the normal boundaries of those patterns. The process also allows users to understand when INEL's are at a point in these patterns that entities would be receptive to change or resistant to change. It will also find points within these patterns when entities are most likely to start straying from the patterns and determine when something should be done. This is all accomplished primarily by enabling an environment where historical patterns are noted that is coupled with a test environment where one thing is noticed for one entity and different options or solutions are tested. The actions that work are stored and those can be applied again either manually or automatically later when mathematically/statistically you see that someone else is at that same point in a pattern. This is the power of the system, and the power of the process, to automate this type of response. This can be accomplished as part of an integration of these INEL based patterns, calculations, and analysis with existing organization's systems or this can be accomplished by building all of these capabilities within this new system. While the best approach will probably be to build all of this into a new marketing automation system, initially it may have to be offered as a supplement to existing systems in order to gain market share.

All of the following examples are based on interactions with INEL and the information and insights that are gained from INEL. The following actions may occur in other systems; however the results will be assimilated back into INEL, where the new information is processed and stored for future applications and for any necessary adjustments to current INEL calculations or predictions. At first there will be a manual test and save and learn phase in order to teach the system. And the system can then apply these things automatically, letting you know that it's done them, so that you can go back and look over and adjust them. Or the system can do it automatically and come back and report to you that automatic things did not come out with the results that were expected which, alerts you it's time to go back and rethink what you're doing. The system will also become self learning, in this mode the system will see that things are changing, will test and try something that has worked before, the system will understand that that solution did not achieve the desired results, and the system can either come back to the user with suggested new actions to take, or the system can go ahead and test those new actions that it is suggesting on a limited number of entities and come back and report to you whether it has been successful or not.

The system then 24/7 (or in a individual or batch process until the system is fully matured), with the insights gained from constant data feeds from throughout the organization (data sources were discussed earlier), tracks those patterns, notices the beginning of changes in those patterns, notice when entities are acting within those patterns, when entities are changing out of those patterns, when patterns are likely to be receptive or resistant to changes, and when those patterns are breaking and what new patterns are forming. This is INELMA—you can see market changes long before you would if you were looking at segments or patterns that are just based on one dimension of behavior. You can watch the market begin to change instead of waiting until it has changed and a large portion of the market has already changed. INELMA allows a much finer look at what market patterns exist, when they are changing and how they are changing. This would allow users to proactively determine that change is happening and alter their interactions with entities that have not even changed yet in anticipation that they are about to change. This creates a great bond with entities. You stop sending them things that they are not interested in, and you start sending them things that they are interested in at the points in time when you are predicting that they will become interested. Other systems attempt to accomplish this; however the basis of their analytical predictive insights is far different from a level of granularity, automation and multidimensional modeling that exists in INEL.

In the INEL system there are allowances for inputs from entities, so entities can state what they want or do not want and then you can determine where and when in the INEL you can make that happen for them so they can get off of what would normally be their INEL pattern. If you have INEL as your source for entity information and tracking, you can leverage it to retain entities by knowing what you need to change, whether that information is obtained from observance of other entities that are on the same INEL, or whether that information is obtained from direct inputs from entities.

INEL from many entities that have similar patterns, either in the past or predicted for the future, can be combined to create a Similar Individual Nano Entity Lifecycles (SINEL). SINEL can be used the same way that “market segments” are used today—a collection of entities that share characteristics. The difference is that the entities in a SINEL are being tracked at an INEL level by the INEL system.

This aggregation or collection of similar INEL can be used like a market segment is used; however, the SINEL can have far more in common than a typical market segment, based on how you define and build the SINEL, since market segments are generally only based on past behavior. Remember that there can be a past SINEL (entities who share past lifecycle similarities), a future SINEL (entities who are predicted to share future SINEL and a total SINEL (entities who share both past and future SINEL behavior patterns. Now we can segment entities based on exact similarities that span multiple dimensions, parameters and timeframes. We can target “groups” who will all share enough as many traits as we specify. We can truly focus in on a “group” as if it was an individual.

Aggregating all the INEL's, from all entities, allows the system and users to see how diverse or similar the behavior patterns are. Without aggregation, this kind of review across all INEL's is not possible and the ranges of variances in the INEL's behavior patterns are not readily available.

Benchmark INEL” (BINEL) is a pattern based on all of the INEL for all of the entities that have been determined to fit within a SINEL. In order to do this, the behavioral patterns of the INEL that have been found to be similar, and therefore could form a SINEL, need to be analyzed and one or more standard, average, mean or other statistical variation of those combined INEL behavioral patterns must be created. This BINEL can be used to represent the standard, average, mean or other statistical variation of all of the combined INEL. This BINEL can be used as the basis for further analysis, calculations and predictions of the lifecycles for the entities that share similar INEL patterns and can be grouped into a SINEL.

Using the INEL system and approach will allow many different actions from the organization, including but not limited to:

Better prices and other incentives tailored to the entity's future value to the organization.

An organization can automatically, semi automatically or manually give a better price, service, product or other benefits to known entities who are repeat entities, repeating from your loyalty program, or who are unknown entities, and have a future predicted value (strategic or lifetime) to the organization that supports these preferred prices. In prior art this is not done dynamically because there is no basis in existing pricing systems to do this and future values of entities are straight line averages of their past values.

The system when calculating what price to give an entity, or when calculating any other interaction with an entity, can now calculate that based on not only their past value as a entity which is what traditionally has been used, but we can also now use the INEL and marketing can make decisions based on future value of an entity whether it is a tactical value (the value for just this one action or interaction), a strategic value (the value over a given future time. It goes beyond this one tactical interaction) or a lifetime value (which is the value of the entity over their entire future anticipated lifetime or INEL). Any time frame can be defined as the value, and the value can be calculated for each entity for that time frame. Then you can use these different time-based values to base your dynamic entity centric pricing, and using BINEL you can determine what the value of that one individual entity will be over any future given time period. This will allow marketing to truly zero in on the cost of acquiring or retaining entities.

This approach can be automated by determining what time frame value you want to use for a person in a given situation, or for a particular promotion, event, etc. And then you can apply that same value automatically for other people who your system says are in a similar position in a similar value in a similar INEL. Again, the idea is to determine who you want, when the decision needs to be made, to test different responses to that need, to find that the action that appears to be best. Then you automate actions in the future for people in similar situations who are a similar value or similar INEL (and the amount “similarity” that is needed to incur these actions can be user or system defined) and to track the future application of this finding to determine when it needs to be evaluated again and/or changed. The prior art did not allow value calculations for entities in the future to be based on the full patterns of their expected and predicted behavior broken down to each dimension of interaction and then aggregated into classifications. This is far less accurate than INEL where the predicted future behavior of an entity is known based on that entity and their current behavior, and then the future lifetime value of an entity can be based on what they are expected to do and are not based on an average of their past behavior.

An organization can develop websites where your known entities register and have an alias. You can track their actions there and know who they are and then see if that data assists with INEL.

The nano entity INEL allows the calculation of an endless number of different future values for an entity, with a much higher degree of certainty, than in the past. These can feed into many other calculations including loyalty, CRM, and pricing, etc.

In order to understand the future value of a entity, you need to look at the INEL that they are on in the future, their BINELs, which is the expected benchmark for their future behavior patterns in their INEL, and you need to look at all of the expected points of interaction with them in the future along with their INEL curves and add the value of all of these up to get a total future value. Because most INEL will be shown and presented with the x-axis being the time we can do this and include the value and how much time is covered and create time slices.

The ability to graphically show users an entity's expected future INEL, the probabilities and deviations associated with that user and their past INEL and/or expected INEL and remaining on it. As well as how far they have strayed so far from INEL, with the standard or the deviations showing where they're most likely to stand against the BINEL, allows users to very quickly understand the future potential and value of a entity. Presenting the same information in a printout with numbers, or even in another type of graph that is not set up this way, makes this task of assimilating this knowledge much more difficult.

Different pricing for entities does not have to come out of the margin of the organization selling the product. It is possible through the predictive analytics of an INEL to tell the manufacturers or service providers which entities they should be targeting and what their future value is. Within the product manufacturers or service providers could offer coupons or incentives to those entities to purchase the product. This way you maintain price parity at the entity facing level and the discounting is being done at another level. This allows INEL to be applied to markets that cannot traditionally offer customer centric pricing.

INEL, MINEL and BINEL can be given names and identifying labels that can be used in conversations or indexed for use in searches—to allow them to be talked about at a subject marketing level and also used in analysis and easily found at a deeper analytical level. This is another example of how the structure, hierarchy and use of this concept will allow these statistical results to be much more easily understood and used by members of the organization. This huge array of statistical results is no longer the sole domain of statistics and math oriented people.

### Better Segmentation

The concept of using INEL with entities allows for much finer multi dimensional segmentation than is possible when the segmentation is just using one or more dimensions or variables from one or a limited number of time slices and you do not even know what other dimensions the entities have, let alone their status in the other dimensions. INEL are used throughout all the time periods of an entity and with all variables, dimensions or parameters. An INEL is not a singular observation it is a total observation that allows individual pieces to be used if that is beneficial.

The prior art, as an example, normal segmentation would say that someone is a $200 per visit entity because it captures one factor at one period in time. An action might be taken towards all entities who match those criteria. Normal segmentation, targeting or entity insights/information can capture other factors, but each must be modeled separately and then all the results must be combined.

### Better Predictive Analytics

The INEL will also track and tell you the probability of someone staying on an INEL based on their past behavior and where they are on the existing INEL and what lies ahead for them on that INEL. This will tell you how much confidence to place in someone staying on the predicted pattern and will also tell you when someone should be moved from an existing INEL pattern on doing another pattern are said to not be following a pattern.

The goal is an entity level tracking and forecasting and interaction approach which allows entity interactions to be predicted, tracked and analyzed. From this understanding you can optimize both demand, supply and the enterprise or any other area and then put them in an equilibrium status for the entire entity.

One can obtain Nano detail and very early notice of market changes since you will be able to see them occurring one entity at a time, and you can quantify how many are changing, how they are changing, how fast—before the “segment is even changed!

An example of INEL would say the following using standard deviations, or deviations with a special “weighting or “parameters” of someone at that point in that INEL. The entity is (first the historic facts) a $200 per visit entity who came 10 days ago on a weekend, spent $185, (now for the future predictions based on the INEL that they are on and the expected behavior of someone at their point on that INEL) has a 80% probability that they come again in the next month on a Saturday, how often they will come, will spend between $175 and $220 dollars, will buy this or these products, services, etc., is prone to do a certain thing at this point in their INEL, can be influenced to do or not to do that thing by doing this, can be influenced to do something else by doing this, . . . a vast array of predictions, observations, proactive and reactive points can be called upon about this entity. The way INEL are captured, develop, analyzed, communicated to users—all means this data is readily available and much easier to digest and use than numerous tables of regression or other statistical values. You are creating multiple different dimensions within one entity. One dimension cannot describe an INEL so INEL forces users to have multidimensional understandings of entities and then utilize that information since it is readily available.

Following the patterns in INEL and MINEL will allow organizations to more intelligently plan and offer cross sell and up sell opportunities.

Index numbers or factors can be calculated for each INEL and MINEL that will allow users or the system to rapidly search through many INEL and MINEL to find the one(s) that are right for a particular need. Then a grouping or segment of entities can be identified and aggregated for a particular action. This is very different than creating a group based in one or a few dimensions.

These identifying numbers can also be calculated each time the INEL and MINEL is recalculated after each change in data for that entity or calculation of their INEL and MINEL.

Aggregating all the INEL's, from all entities, allows the system and users to see how diverse or similar the behavior patterns are. In the existing art, only the INEL's that defined behavior patterns are aggregated, therefore, this kind of review across all INEL's is not possible and the range of variances in the INEL's behavior patterns are not readily available.

### Graphics

The use of graphics will allow less analytical people to quickly grasp and assimilate the information being presented to them and also to quickly view an array of data and do what is needed given our different scenarios with the array data. Doing this with just the numbers would be unbearable because of the volume of numbers that would have to be assimilated and the patterns cannot be as easily recognized by people in a table of numbers as they are when it shown graphically.

Use a lot of graphs and graphics to display behavioral patterns. On one example the x-axis might be time so that all of your graphics can have a time series component. One graph might have all the existing INEL that make up an entity with X is a date/time axis and then they show a MINEL on the same graphic. This presentation will make the information understandable and actionable. Another INEL might make the x-axis number of visits, etc.

Within the graphical interface one can also show what if scenarios with the possible results which will allow the user to grasp historical scenarios as well as future predicted scenarios all in the one piece of rapidly digestible information.

In one type of display, the MINEL needs to be shown graphically in a continuous line with time as the x axis, whether it is an INEL being shown or the MINEL being shown. For future periods, the BINEL needs to be shown, with the expected standard deviations also shown. This will allow the viewer to see how far from the benchmark the entity has been in the past from what was expected as the norm. For future periods in the INEL than the average or mean INEL should also be shown and again the average or standard deviation for that should be shown at the same time. This will allow a user to quickly look at an entity and determine how close to what is expected of someone in that INEL they have been in the past and what their behavior should be in the future if they display behavior that falls within the acceptable ranges of deviation. This needs to be done for each of the INEL that an entity is following.

Then the INEL need to be combined into a MINEL. Each MINEL can be shown on a separate graph, or all the INEL can be shown on the same graph. The MINEL can be shown by itself. Or the MINEL can be shown with all of the INEL at the same time. The acceptable or standard deviations off of the INEL, whether INEL or MINEL, can be displayed numerous ways including a shaded band running alongside the INEL of above and below. This would display acceptable or expected deviations from the INEL both in greater or lesser values of whatever dimension or parameters being displayed along the Y axis.

If numerous INEL are shown with one graph, there may need to be numerous Y axis shown. This may require some unique types of graphs with multiple Y axis and with values on the Y axis that are somehow normalized so the size of the Y axis are similar if not identical between INEL even though the values being measured on those Y axis have very different dimensions. Showing the multiple INEL on one graph will allow the human mind to assimilate this data in a manner that will allow it to make sense.

Showing INEL on individual graphs will allow one to concentrate on each INEL, however, showing a CINEL on one graph will allow the viewer to understand the multiple paths that an entity is on and how they are overlapping, interacting, or somehow associated with each other. In effect, this is taking the behavior of an entity and breaking it down to its lowest level of detail and displaying it in a manner that allows it to be absorbed mentally and the interactions between the different behaviors can be seen and understood and then also showing all of the behavioral patterns of an entity together on one graph.

Showing INEL and the CINEL as tables of numbers will not work. Almost no human mind can read all of these numbers and mentally draw the patterns that are associated with the numbers and the INEL. The patterns are what need to be recognized here and patterns are best recognized and seen graphically. Unlike prior probability calculations, INEL are not focused on just one or the next probability of occurrence their focus is in the long-term are lifetime journey of that entity and the probability for all of the later actions which might occur in the future. This is quite different from just focusing on one probability or one action or one interaction at a time.

Command, Control, Communication & Intelligence System Interface

With all the predictive entity behavioral power of the “Individual Nano Entity Lifecycles” (INELs), they are only the predictive portion of a larger effort to optimize profits. To be 100% effective in assuring that this new behavioral predictive analytics is optimally applied an organization needs to see and orchestrate all of the areas in the organization that entities impact. If the organization does not assure that all the areas of the organization are coordinated, and then using INEL's to predict what the entities will do is useless knowledge that cannot be applied. This is where the C³ISI (Command, Control, Communication & Intelligence System Interface) is needed to leverage and assure that the predictive behavioral knowledge about INEL's gets properly used and managed.

C³ISI is a computer portal or screen, which is one part of a new Entity Behavioral Optimization System/program. This new tool allows the user to have an aggregated view of all of the many different existing user interfaces, systems, points of information or predictions, data sets, etc. that deal with entities and their interactions with the organization in one user interface. The user can now easily see and balance all the predicted interactions between entities and the organization on the demand, supply and enterprise levels using one program and one computer screen. The interface can include many different “Windows” which are live representations of other existing and/ live systems. This can be done in any computer environment including Windows, UNIX, mainframes, cloud computing, etc. There could be a first interface created for all areas that influence entities involved in the demand process of organization. There could be a second interface which pulls together all the areas that impact the entities on the supply side of the organization. There could be a third interface that focuses on the areas both on the supply and the demand sides of the organization, and this will be called enterprise lifecycle automation. Other areas can be created and defined by the user as needed and managed with C³ISI. Each of these is a set of windows into different systems or data that are programmed to appear in one computer screen.

The user can determine which windows will be seen in the interface display, where those windows are positioned, the size and shape of those windows, and whether to expand one window temporarily to encompass the entire screen or part of the screen (accomplished either automatically or manually). The user also has the ability within any one of these windows to drill down within the system as if they were just viewing that systems interface. C³ISI enables users to view and interact with all of the areas where entities impact the organization whether or not that area is currently capable of being reviewed and/or controlled by the organization within one computer program and screen.

In addition to this capability, the C³ISI also allows the user to define intelligent capabilities that the C³ISI will perform either within a window or between any groupings of Windows. C³ISI is more than an interface and has modeling, reporting and analytical capabilities. Examples can include, exception reporting, reporting, alarms, rules-based engines, predictive analytics, probabilities, what if scenarios, goal seeking, etc. These intelligent capabilities add great value to the C³ISI by making it far more than just a window onto multiple different interfaces. This allows the C³ISI to be an analytical tool that can stretch across the organization, while allowing the user to view all of the sources of data and information and modeling that were used for the analysis which was directed by the user across all of these different information sources.

Some Further Benefits from C³ISI are:

The concept of centralizing all data and decisions that can affect demand, all data and decisions that influences supply, all data and decisions that influences the equilibrium of the entire enterprise, and/or any other areas of the organization in one interface or series of interfaces. This allows a user to assure that all the areas of an organization that affect a given area can be seen in one place and interacted with in one place to assure that the current and future actions of all entities across any portion of the organization are optimized.

This allows the user to assure that all the actions of the organization, which take in these many areas, are aligned. Many times and in many organizations the actions that affect an entity that come from the demand side of an organization, the actions that affect an entity or a KPI (Key Performance Indicator) that come from the supply side of the organization, and/or the actions that affect an entity that come from the enterprise are not in alignment and can even be contradictory. An example of when different areas of an organization are not aligned is when one area gives someone a special price or incentive to make a purchase and then at the same time another part of the organization disqualifies that customer from making that purchase or does not know that the product is not in stock.

With the C³ISI, the outputs from one discipline or system (marketing, pricing, distribution, CRM, inventory, shipping, logistics, supply chain) can be viewed and their impact predicted as one action becomes the input for another system and visa-versa. The data flows between them and their combined impacts can be systematically accessed in one screen.

The windows within the interface allows the user to see the other systems and/or models so the user can see these live feeds concurrently side by side and can then go into a window to enlarge it and take actions, etc. However, the user can also allow the interface to have rules based engines, exception reporting and analysis, graphics and reports that combine information from all or any of the sources included in the C³ISI.

The user can tell the C³ISI a particular date, product, service, parameter, situation, etc., or any identifying factor(s) and the C³ISI will query the many systems that it is connected to in the “windows” that can be shown within one screen and bring up information about that instance in all the “windows” in C³ISI. This allows the user to quickly see the status and actions across all these systems, in one interface, that have an effect in this instance so the user can access whether they are in harmony and all following the same goal(s).

To reach the ultimate goal, an enterprise C³ISI, which is to automate the timing and process of pricing and marketing CRM (Customer Relationship Marketing) and loyalty goals, the supply-side of the organization needs to be keyed into what could be needed on the demand side of the organization as derived from the predictive analytics in the INEL.

Supply needs to follow demand, and the demand needs to be customized, individualized and very entity centric based on INEL patterns. Therefore the system need is created to tie all of this together, the demand and the supply—at the entity levels in one interface where the equilibriums can be seen and adjustments can be made at the entity levels (INEL).

With the C³ISI systems input window, the user can input any parameter or parameters and the C³ISI system will find that occurrence or occurrences in each of the screens that is selected by the user to be able to appear in the window. If no windows are preselected by the user the system will find all the screens/windows where that input is identified. This is very powerful and allows the computer to find and display the areas that the user wants to check to assure that they are in the proper focus and alignment.

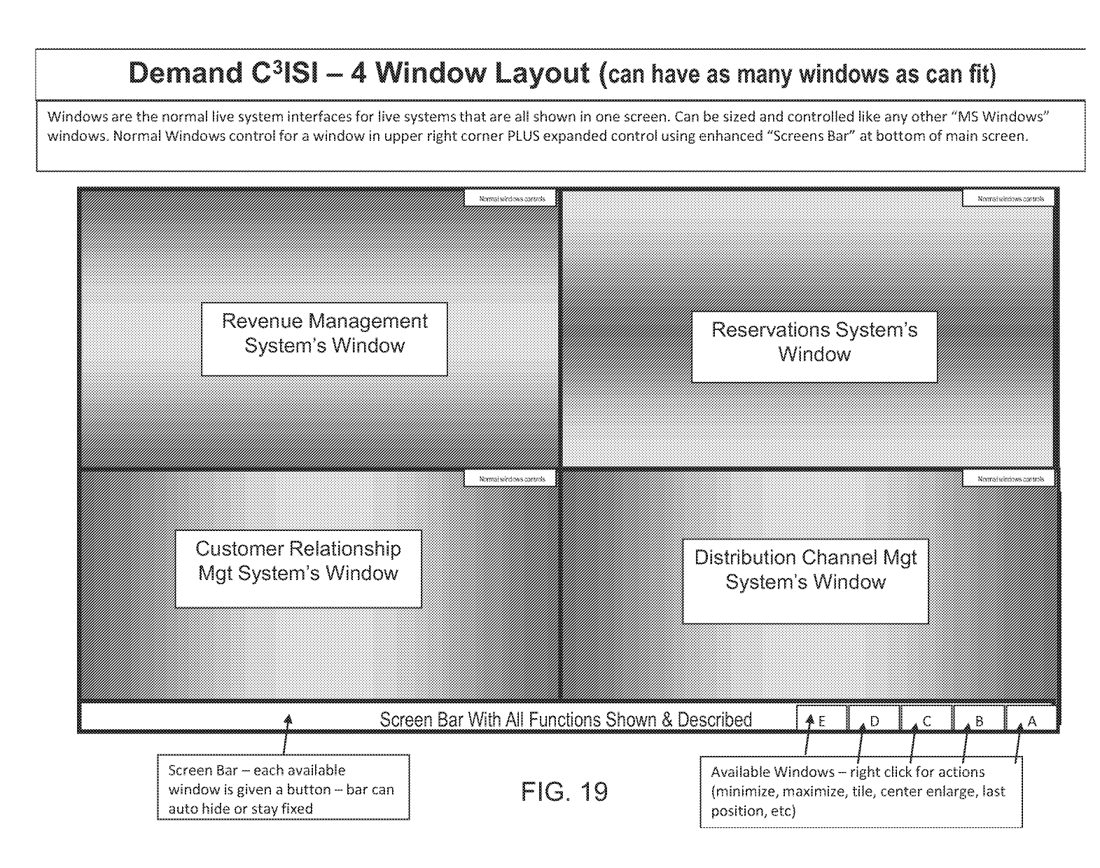

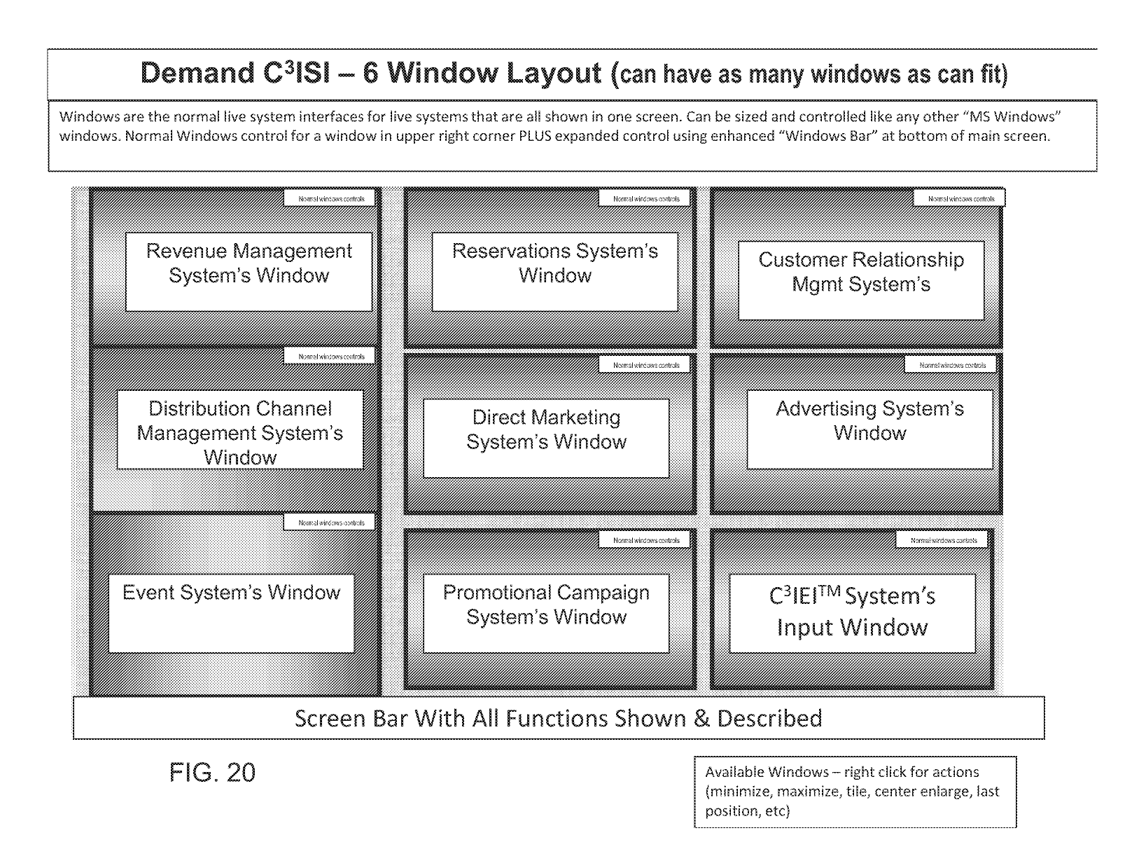

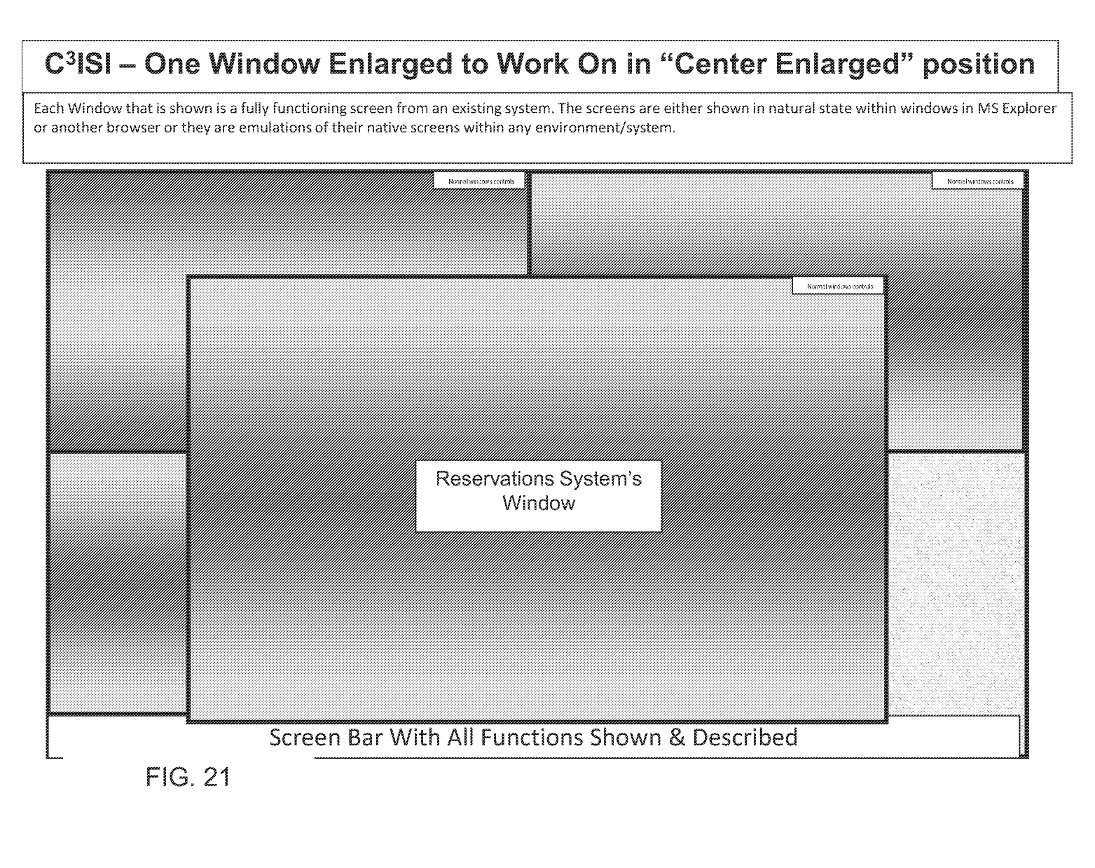

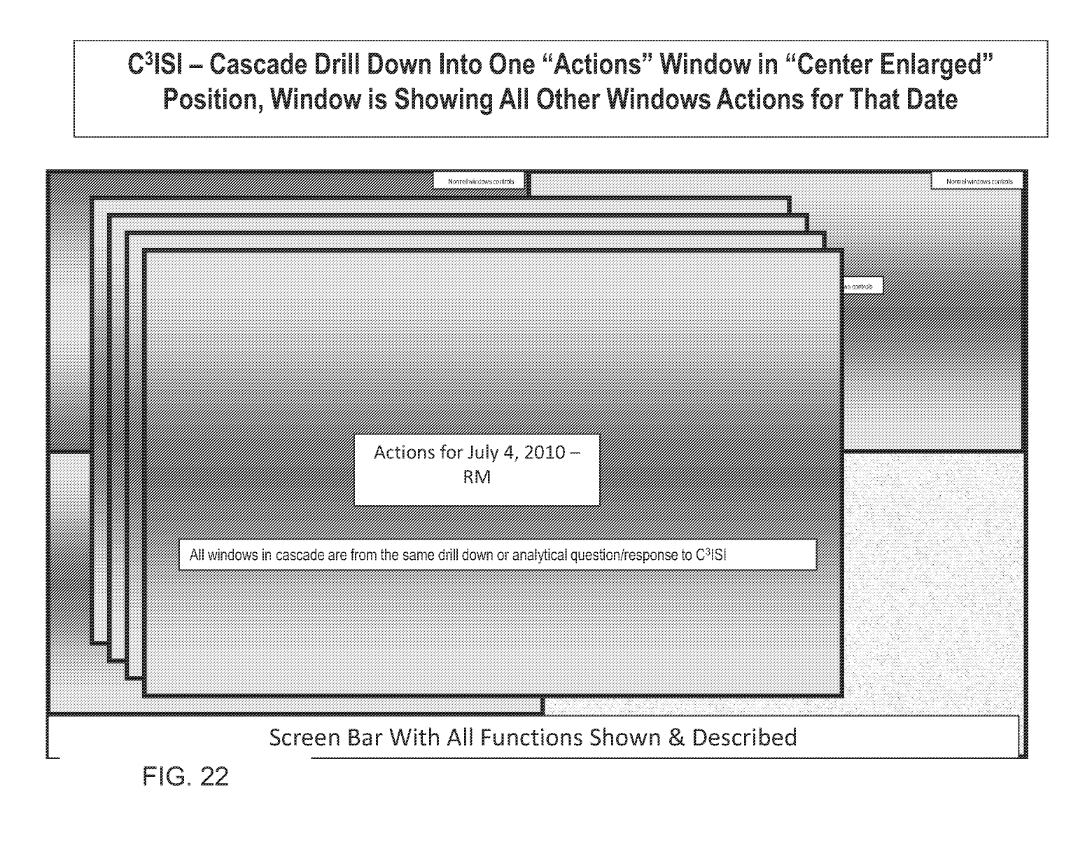

FIGS. 19 through 22 show examples of a command, control, communications and intelligence entity interface C³ISI screen. FIG. 19 shows an example of a four window layout for the C³ISI. It also shows the window controls and the opening order of each window, in the new screen bar at the bottom of the screen, which can be used to select which of the systems, will show up in the main screen as a separate window. FIG. 20 shows an example of a six window layout for C³ISI. The window that is open in the bottom right is the action window which is where the user can make inputs requesting the system to show certain information. FIG. 21 shows an example where one window in the C³ISI is “center enlarged” so that the user can easily work with that window. FIG. 22 shows an example where one window in the C³ISI has been “center enlarged” and the user has “drilled down” within that window. FIG. 22 also shows an example of a four window layout with one window showing all of the actions for one date across all systems. This window is open in the center, and has a series of drill down windows behind it where the user can go to get more detailed information on the query.

Any combination of windows from any areas of the organization, or even windows from outside of the organization, which can be called upon, can be selected by the user. Each of the separate systems interfaces is shown within its own window within the user's screen. This can be done in either a Windows environment, using Internet Explorer, or any other environment.

All of the windows shown within the C³ISI are live and appear and operate just as they would if they were being viewed by the user alone without the C³ISI screen. Ideally the windows that contain each of these separate screens can be manipulated, sized, and controlled just like any other “window” in a Windows environment. However, they are not limited to these controls.

The normal control buttons that one would see on a Windows window can be placed in the upper right hand corner of each window. These are the normal Windows control buttons that include a red square with an “X” that is used to close the window, a grey square with two cascading squares that is used to make the window smaller and allow it to float within the screen, and the gray box with a flat line which is used to minimize the window so that it no longer appears on the screen.

There can also be a “screen bar” along the bottom of the screen. This “screen bar” can contain an icon showing every window that is either open and/or every window which can be opened. The screen bar can have an auto hide feature or can remain static like the Windows taskbar. Right clicking on the icon for any window within the screen bar allows the user to take any of many different possible actions on that window. Such actions can include, but are not limited to minimizing, maximizing, tiling, placing the window in the center of the screen in large format, bringing that window up onto the screen in the last format that it was seen in, etc. The controls just described may be used throughout all of the C³ISI windows.

The checkered looking horizontal bars shows the back of the user's screen which is not covered by any of the windows that have been selected.

There is a C³ISI systems input window. This window shows a screen which can be accessed for the C³ISI program to put in parameters for requests like alarm exception reports as well as parameters that force the C³ISI to automatically input the same dates, promotion, or other specific identifiers into all of the windows within the C³ISI. This would allow a user, for example, to put in a date or range of dates and a parameter, and have the C³ISI show, in each of the windows, for each of the systems that are being viewed, what that system is doing for that date or range of dates for that parameter.

One window can be “center enlarged” so that the user can easily work with that window. All of the other windows that the user has requested remain tiled in the background. Then the user can “drill down” within that window. All of the drilled down windows can be shown cascading in the center of the screen.

The C³ISI systems inputs window can be used to select one date for all of the other windows to focus on. This screen could be set up so that as the user clicks on each window within the tiled layout, that window pops up into a center enlarged position.

### Nano Entity Economics Requires a Combination of INEL and C³ISI

The demand needs to pull the necessary supply in order to reach the optimum demand-supply equilibrium. In many systems today, supply is generated without a close enough connection to the demand. Surplus supply exists, none of the supply exists, and/or the right supply does not exist. This creates a demand-supply imbalance, which many times forces demand to try and get the market interested in supply which that demand curve is not really interested in at that time. This lack of the equilibrium creates an imbalance that harms profits.

To avoid this, the demand and the supply sides of the equation needs to be broken down and tracked at the level of each entity. This allows for a much finer understanding of what the entity-based demand truly wants, and therefore what the organization needs. Then the demand and the supply equilibriums must each be optimized and the entity level across all the areas that effect either demand and/or supply. This enables the organization to create the appropriate supply for the appropriate demand and control both at their respective levels as well as at a combined entity level. Today, many times supply is created, and then demand must be found. While some of this will still occur even with the nano entity economics demand-supply equilibrium based on nano-entity marketing (marketing at the smallest level), and non-entity supply production, the occurrences of this can be greatly reduced if sufficient tracking is done at the entity level on the demand side, and if this is used as the trigger for many of the actions on the supply side in order to achieve an enterprise entity balance and equilibrium.

Before this invention, there was no true system with a cause-and-effect linkage like this between demand and supply that occurs within the organization. In the prior art, most of the demand supply balance or equilibrium occurs out in the marketplace. This wastes profits. Companies, organizations, whatever is producing supply and trying to find demand that is interested in that supply, needs to understand this and needs to start trying to balance its demand and supply internally based on a much better understanding of what its entities request and want. As well as balancing within the demand and supply sides of the organization. INEL and C³ISI are both needed, combined in the system and program described in this invention, to accomplish these goals in a formal, systematic and repeatable entity centric fashion across the enormous range of decisions that will need to be made in an organization.

Rather than proceed according to the prior art, the present invention strives to find an entity centric equilibrium, both within the demand curve and within the supply curve, across the entire enterprise and any place else the user has defined. This is built from each entity, up to the market segment level, and then to the mass market level. The supply-side of the organization is able to watch, monitor and track the building of this demand and react appropriately. Conversely, the demand side can watch the supply curve and react appropriately trying to create the right types and timing of demand to match the anticipated supply curve. This allows an enterprise to anticipate the needs and desires of its entities and to have that supply and/or demand ready and available when the entities demand curve and/or the entities supply curve is at a point where that is what they are asking for.

The worst thing an organization can do is have to try to exert the effort that is needed to shift the demand curve to meet the supply curve. That requires a great deal of investment and a great deal of marketing to shift perceptions and desires of this many entities in the market. However with the tools in this invention an organization can better understand what the demand curve is going to want and anticipate and have the supply produced, then the organization will be able to place a supply curve in the path of the anticipated demand curve.

It is desirable to have individual models, processes, and systems, which can be used either systematically, automatically, semi-automatically or manually, and when combined can create a total end to end enterprise optimization and equilibrium optimizes the demand side of the equation, and optimizes the supply side of the equation, and then put those in equilibrium and track and monitor that equilibrium while enabling the user to spot potential imbalances before they occur and/or to react to them swiftly enough to minimize any impact on the equilibrium between supply and demand. This is all driven at its very core by INEL at the entity level. Then entity analysis can be used with C³ISI to understand the demand curve for the supply-demand of enterprise equilibrium.

In the equilibrium phase, with a product that is either perishable or is limited in quality, the organization also needs to have the revenue management or profit optimization system in place to ensure that the most profitable demand gets the constrained supply or resource. This should be a bid price revenue management system that calculates a breakeven price based on displacement values of unconstrained demand. However, an entity pricing system can still be used, because the organization can use a bid price system to determine the hurdle and then based on that the organization can use the entity centric dynamic pricing model to determine whether that entity automatically qualifies for a price that is over that hurdle, whether that entity should have the price lowered based on their future strategic or lifetime value, or whether that entity should somehow have their purchase price subsidized by the organization as an investment in longer-term relationships.

This may bring in a new age where instead of investing money in acquisition and marketing to retain entities, an organization actually subsidizes and adjusts dynamic pricing to retain entities. It is much more economical to retain existing entities rather than to acquire new entities. The MINEL marketing approach, based on a bid price revenue management system, can address this by determining dynamic pricing and what would be needed to retain that entity by giving them a price that is subsidized. Then the question will be whether that subsidy for that entity is better than the acquisition cost of trying to bring in a new entity or if it is better than the retention marketing cost of trying to retain that entity. Again if there is unlimited supply this may not be as much of an issue as when there is a limited perishable supply. However, in both cases the entity centric dynamic pricing needs to be looked at as a marketing tool and as an investment in entity loyalty.

Nano entity economics cannot work without the INEL curves or patterns at both a detailed INEL and MINEL level. These are two symbiotic concepts.

The reason nano entity economics is needed to track an organizations entities along the supply and the demand curve is that the movement and shape of that demand and supply curve is determined by all of the many individual actions of the entities within the supply and demand curves. Therefore it is necessary to track all of these actions at an entity level to understand at an atomic level what is going on and what is likely to go on in order to find the equilibrium between those supply and demand curves in nano entity economics.

For nano entity economics to work across a total enterprise optimization schema there has to be some way that the demand being forecasted pulls the supply, or deletes it, before too much or not enough is created. Demand should lead supply and Nano Entity Economics, based on INEL, will allow organizations to realize this goal.

It is all of these actions or interactions that are happening based on INEL level actions and predictions, and C³ISI—that are predicting and creating certain actions or interactions that need to be understood in order for the concept of Nano Entity Economics and INEL to be used as the basis for demand or supply decisions that lead to enterprise equilibrium.

Even if profitability across all these areas in an enterprise scope cannot be optimized and constantly kept in equilibrium, what is being done at the entity level within each of the demand and supply curves is in and of itself going to optimize profits. Optimizing entity relationships across the supply and demand curves or any other areas defined by the user is in itself a great step towards profitability and efficiency, whether or not an organization is able to do this all the time in all places. It is the concept that matters and getting close enough to do it is far better than not trying to do it at all.

True profit optimization is not just selling the organization's products at the most profitable price, it's creating the most profitable mix of products at the most profitable prices to match demand, not just the profitability on the existing inventory. What needs to be optimized is the profit on what would be the optimal inventory to meet the demand. It takes concurrent balancing of the equilibriums on both the demand and the supply side to accomplish this, which is where enterprise optimization in equilibrium at an entity level based on INEL is needed.

Predictive INEL's are needed to achieve demand optimization and supply optimization and to attain enterprise equilibrium and optimization. In other words, seeing things at the entity level with INEL's or predicting the actions at this level, allows the determination of what is needed to balance the demand equilibrium and the supply equilibrium, and also to make sure demand and supply equilibrium are both balanced in an enterprise optimization equilibrium state.

In order to do nano entity economics, some kind of engine or system that can track entities at a high degree of detail and certainty is needed that can be relied on to accomplish demand optimization and supply optimization and enterprise optimization and the three equilibriums that are required at the demand, the supply, and the enterprise level. In nano economics an organization's interaction with entities is based on the one entity to one entity interaction level with the organization. It is very individual and tailored and it is not segment based. Nano entity economics tracks entity behavior, either at the entity level or at larger segment levels, for each type of behavior, by one entity at a time through all interactions. This tracks them through their history and it will track them through their predicted future interactions. This can all be showed in one cumulative display.

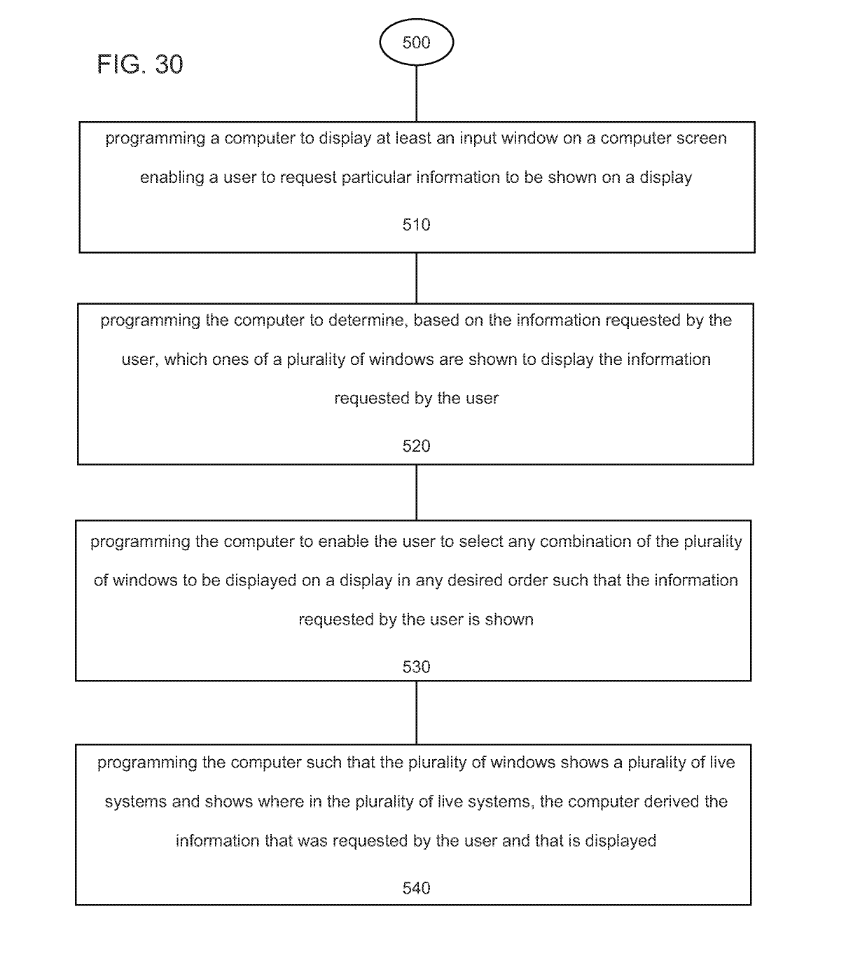

The C³ISI can be configured to perform most or all of the functions described above. The C³ISI can be implemented using a computer 10 by programming the computer 10 to perform a computerized method 500 of displaying information. An example of the computerized method 500, which performs at least a few of the features of the Command, Control, Communication & Intelligence System Interface described above, can be seen in the flow diagram shown in FIG. 30. Step 510 includes programming the computer 10 to display at least an input window on a computer screen enabling a user to request particular information to be shown on a display. Step 520 includes programming the computer 10 to determine, based on the information requested by the user, which ones of a plurality of windows are shown to display the information requested by the user. The windows may show data from the same or from different systems or programs which may or may not reside within the organization. Step 530 includes programming the computer 10 to enable the user to select any combination of the plurality of windows to be displayed on a display in any desired order such that the information requested by the user is shown. Step 540 includes programming the computer 10 such that the plurality of windows shows a plurality of live systems and shows where in the plurality of live systems, the computer 10 derived the information that was requested by the user and that is displayed.

### Benefits

### The Whole System or Invention

A computer based Nano Entity Optimization System (NEOS) comprised of computer driven Nano Entity Predictive Lifecycles Analytics (NEPLA) and a computerized Command, Control, Communications and Intelligence System and Interface (C3ISI).

The computer driven NEOS where the systems in the computer adapt to rapidly changing markets and/or environments and perform as best as possible, using the framework, processes and hierarchies of the invention as defined in this patent, and using the best data and computer driven math/statistics/technology that is available.

### Finding INEL

The computer driven NEPLA where the computer system uses any available data and/or math and/or statistics and/or information technology and defines, discovers and identifies all of the behavioral pattern(s), or Individual Nano Entity Lifecycle's (INEL) for all INEL that can be found in historical data. The computer driven processes and methods where one method of discovering an INEL's is a computer looking at all the available historical data for all entities, and using the computer driven math and/or statistics and/or information systems and/or calculations and/or subjective user inputs and/or whatever other information is available and found to be predictive of nano entity behavior, find entity INEL behavioral patterns in the data, using methods like, but not limited to, statistical clustering and regression analysis. The data fed into the computer can either be filtered by any or many characteristics or the results of the analysis of the data can be filtered by any or many characteristics. Both will have the effect of limiting the data being analyzed to include or exclude certain parameters, criteria, dimensions or any other filtering criteria.

The computer system uses data that is gathered from the organizations web site or other areas of open interaction with or between entities, where the organization allows entities to assume pseudonyms and interact with other entities using those pseudonyms. The organization will know what the true identity of the pseudonyms is and can therefore attribute any of the actions or interactions of the entity to that person and store that as data relating to that person.

### Using INEL to Build a Hierarchical Classification System

A system of data management and data classification that breaks down interactions below the entity level to a sub entity level and has a hierarchical process for rolling some entity interactions into classifications that can be dealt with by the user and easily understood, cross-referenced and used in analysis. Once the process of finding the INEL's has been accomplished, then the INEL can be used as building blocks to build a hierarchy of classifications. The computer driven INEL processes where the computer determines, using computer driven math and/or statistics and/or information systems, how closely the actions of an entity follows the behavioral pattern(s) that have been determined to create an INEL. Whether there is a particular “degree of fit” means that the entity matches the historical INEL can be determined by the computer, or by the user. This calculation is used in further classifications to determine what entities or INEL belong in a classification.

Based on the table in the diagrams there are 8 classifications of INEL and 4 time frames; therefore, there are at least 32 different possible classifications to use. There can be numerous additional variations of these classification types based on how many INEL's there are and how many possible different combinations of INEL's there could be. Future classifications can be built using the INEL's, as needed by future requirements. Index numbers or factors can be calculated for each INEL and other classifications that will allow users or the system to rapidly search through many INEL and MINEL to find the one(s) that are right for a particular need. Then a grouping or segment of entities can be identified and aggregated for a particular action.

With SMINEL, SSINEL and SBINEL the addition of the INEL that are not the core INEL that are being targeted are added to see their impact on the core INEL. Therefore, when adding the additional INEL the system will calculate the impact and affect of these other INEL on the core INEL to so this factor can be understood and applied in further analysis. This is the effect of other dimensions on the dimension that is being modeled or targeted for an entity and these other impacts are very important to understand, quantify and be able to apply later to other entities.

For SINEL and SSINEL when determining their “similarity” and what INEL are deemed to be similar enough to join that classification, the system can test different thresholds for the similarity factor and see what INEL patterns emerge at each threshold. The level of threshold that is used can and will vary by INEL that is being targeted. There can be numerous “similarity” factors used as a filter and therefore many different SINEL can be found and used based on the degree of fit or probability that is needed for an application.

### Predicting Future Behavior

The BINEL and SBINEL classifications can be used by the computer to predict the future INEL patterns of an entity or entities. This means predicting, using a computer and math and/or statistics and/or information systems and/or inputs/influences from the user(s), how closely the entity in question should follow the future behavioral pattern(s) that were followed by the other entities in the INEL, who are also in the same SINEL, and whose patterns were determined in the BINEL or SBINEL.

The computer's prediction of future INEL behavioral patterns for an entity, where a “degree of fit” for an entity predicted to follow the future BINEL behavioral patterns of other entities who are in the same SINEL with them can be calculated by using a computer program for math and/or statistics and/or information systems and/or inputs/influences from the user(s).

Use the computer and INEL analysis to determine the factors that impacted the historical behavior of a lifecycle, and predict future behavior by determining if these factors will be in existence in the future and if so what their future impact will be on the behavior that is being predicted based on what their impact in the past was on past behavior

Where there are patterns the computer system will calculate what is a predictable behavior within an acceptable range of deviation, and calculate when human intervention will need to occur. The system will need to identify those and present them to the users with all of the analysis and that data are available and let the users determine what needs to be done.

The predictions, and as one example the blending of past variances and future predictions, can be automatically or manually weighted to determine how aggressive and individual and how “routine” or average the predictions will be and what inputs and their weightings will be used in the predictions.

To calculate different nano entity behavior predictions using different nano entity information, it may be necessary for the computer to review numerous different factors, access their predictive value and then gather the numerous insights from these numerous indicators and combine them to indicate what behavior is expected.

The computer and math and/or statistics and/or information systems and/or inputs/influences from the user(s) can track an individual or group of nano entities' variances with a BINEL and determine their expected deviation from the historic and predicted future BINEL patterns using math and/or statistics and/or information systems and/or inputs/influences from the user(s) in those variances. Once these variances are understood, for an entity within an INEL, then the variances can be applied to predict the INEL's level of certainty and/or the deviations from the BINEL that an entity is expected to exhibit in their behavior both historically and in the future.

### A Systematic Process and Approach

The procedures must constantly be tracked, recalculated and determined. Calculating what INEL exist, determining which INEL an entity is in, determining the entity's MINEL, determining SINEL's, determining BINEL's, as well as determining all the fits, deviations, predictions and any other calculations using computers and/or math and/or statistics and/or information systems and/or inputs/influences from the user(s), can and should be a constant 24/7 process, not a batch process. Lifecycles are constantly being calculated and determined. During this continual process the changes in lifecycles must be continually calculated and tracked to try and develop predicative modeling to help project what changes will occur in lifecycles.

The system then 24/7 (or in a individual or batch process until the system is fully matured), with the insights gained from constant data feeds from throughout the organization (data sources were discussed earlier), tracks those patterns, notices the beginning of changes in those patterns, notices when entities are acting within those patterns, when entities are changing out of those patterns, when patterns are likely to be receptive or resistant to changes, and when those patterns are breaking and what new patterns are forming. You can see market changes long before you would if you were looking at segments or patterns that are just based on one dimension of behavior. Allows users to proactively determine that change is happening and alter their interactions with entities that have not even changed yet in anticipation that they are about to change

The results of the analytics and predictions and categorizations and understanding gained from all of the prior examples can be applied and used in many other existing and future systems throughout the organization. These results can be used in almost any system in the organization that deals with demand, supply, or the enterprise level since all of these are impacted by the behavior of entities.

Nano entity lifecycles and all of their classifications must and can be tracked based on all available nano entity information. Tracking this at both the INEL levels and their aggregate classification levels allows for rapid learning and adjustments. After each new action or interaction with an entity, their INEL where that action or interaction should be registered must be reviewed. Based on what the entity did, and what the entity was expected to do, a number of adjustments and recalculations can occur throughout the company on plans and/or thoughts about how to interact or contact the entity as well as what can be expected from other entities in that same INEL.

### Applying the Results

Users can be shown an entitity's expected future INEL, the probabilities and deviations associated with that entity and their past INEL and/or expected INEL. User's can be shown how far an entity has strayed so far from an INEL along with the standard or the deviations showing where they're most likely to stand against the BINEL.

Information gathered can be used to determine what actions to take or not to take with an entity and their INEL and at what point(s) in their INEL behavior patterns. As other entities progress through their INEL patterns, the organization can test different marketing or other actions to determine which actions work the best at which times in an INEL. This information can be stored and then in the future when an entity on the same INEL reaches that same point in the INEL the action which is proven to work the best can be automatically applied.

The processes and classification can further direct the organization's interactions, reactions and actions with entities to understand: 1) when an entity is on the expected BINEL path and no organization actions are needed, 2) when the entity is at a point in their INEL that prior interactions with entities has shown that certain actions should be taken or should not be taken, 3) when the entity is at a point in their INEL where their most recent action(s) indicates that an action(s) or reaction(s) should be taken by the organization—and hopefully this point in the INEL has been tested before and the best course of action has been stored and can be applied. This requires the NEPLA to be tightly integrated with the marketing and marketing automation systems and an organization.

The predicted future behavior in the BINEL and SBINEL can be used to allow the organization to understand the future value of the entity over different time periods (tactical, Strategic and lifetime) which can be defined by the user based on what type of entities are needed for specific types of actions and/or events. This can be used in many areas on the demand side as inputs to pricing, revenue management, marketing, CRM, etc. This can also be used on the supply side to better understand the future value of suppliers or logistics partners.

The system when calculating what price to give an entity, or when calculating any other interaction with an entity, can now calculate that based on not only their past value as a entity which is what traditionally has been used, but we can also now use the INEL and marketing can make decisions based on future value of an entity whether it is a tactical value (the value for just this one action or interaction), a strategic value (the value over a given future time. You can automate this approach by determining what time frame value you want to use for a person in a given situation, or for a particular promotion, event, etc. and then you can apply that same value automatically for other people who your system says are in a similar position in a similar value in a similar INEL.

The processes in SMINEL can allow organizations to 1) look at entities that have more than one INEL and determine the impact of various combinations of INEL's, with entities in various stages within each INEL—and the degree to which each combination is either good or bad and the potential impact on each INEL that the various combinations of INEL's can have on each individual INEL, 2) determine which INEL behavior patterns tend to produce the best and/or most profitable entities for a product of the organization. The organization can then look at the way these entities began their relationship with the organization and use this to try and foster this type of behavior and find this type of entity.

The processes in the prior examples can be used and applied to the Customer Relationship Management (CRM) and Marketing programs in an organization. These processes will allow an organization to understand many things about customers and their past and predicted future behavior patterns along an INEL. This information can be stored and used when other customers on the same INEL exhibit the same behavior(s) or reach the same points in the INEL.

The processes in all of these examples can be used to accomplish either 1 to 1 marketing or one to many marketing (marketing to segments). For one to one marketing the user can use the information gained from the INEL and entities that have been on this path before, to understand the optimal ways and times to interact with an entity that is on that same INEL at the same point today. For one to many marketing the user can target INEL entities in order to find entities that are all at the right point in their INEL at this point in time.

When targeting customers the organization can also see the other INEL behavior patterns of these entities and not just rely on the behavior pattern of the one INEL which is being targeted and used to aggregate entities into this SINEL group. The processes in all the prior examples can be used to create an automated system then tracks those patterns looks for changes in those patterns and notices when individuals are not acting within the normal boundaries of those patterns. You can get Nano detail and very early notice of market changes since you will be able to see them occurring one entity at a time, and you can quantify how many are changing, how they are changing, how fast—before the “segment” is even changed

Through the predictive analytics of an INEL you can tell the manufacturers or service providers which entities they should be targeting and what their future value is. Within the product manufacturers or service providers could offer coupons or incentives to those entities to purchase the product. This way you maintain price parity at the entity facing level and the discounting is being done at another level.

### C³ISI

The C³ISI, for the demand and/or the supply and/or the enterprise levels of the organization where the C³ISI system shows one or more of the screens of any other system within the one screen of the C³ISI system. This allows users to look at one computer screen and see the displays of multiple different systems.

The C³ISI has many features including where: 1) a screen is defined as the existing or a new interface with another, database, process, or anything else that can be seen within a computer screen, 2) the screens that are shown can be any screens from either within the organization, or outside the organization. Any screen from any system that is accessible via computer with an Internet and other connections, can be shown in the C³ISI screen for the user to utilize, 3) the user can determine which screens are shown within their personalized version of the C³ISI screen, 4) the user can select, from a list of screens within the C³ISI screen and/or within a window within the C³ISI screen, which of the available screens to show from a list of screens, which includes all available screens, 5) the user can select how many screens to show in the C³ISI screen, 6) the user can select the position and the size of each of the screens that have been selected to be shown in the C³ISI screen, 7) the C³ISI screen can scroll up, down, right, or to the left, and be made larger or a smaller resolution, in order to allow the user to access as many screens as they want to show on the C³ISI screen, 8) the C³ISI system can have multiple tabs within its window to allow multiple screens, with the same capabilities as the first screen, to be accessible within the one physical computer monitor screen, 9) the screens from other sources that are shown within the C³ISI system screen are fully functional, 10) the users can preprogram “views” which are the screens they want to be shown, and in what order are placed on the C³ISI screen, and saves these under different user profiles that they can access once they have logged on, 11) these screens that are shown within the C³ISI screen are shown using Microsoft Windows™ and Internet Explorer™, where each of the separate screens that are being shown comes up in their own “window” within Internet Explorer, and has all the functionalities of any other floating window within an Internet Explorer screen, 12) the screens that are shown within the C³ISI screen are from sources that can be captured and shown by Microsoft™ within a Microsoft window within Internet Explorer™, 13) the screens that are shown within the C³ISI screen are shown using emulation software to convert the normal display interface for the system into a format that is compatible and can be shown as a window within Microsoft Internet Explorer™, 14) the C³ISI system does not exist and/or cannot be shown within a Microsoft Windows environment, and/or cannot use Internet Explorer™, and/or cannot place the systems that needs to be displayed within independent floating windows. In this case, the environment and software where the C³ISI system is operating will be programmed to try to emulate the capabilities of Windows™, Internet Explorer™, and floating the individual windows within Internet Explorer™.

The C³ISI, whether in a Windows™ environment or another environment, where users can configure different screens, or a series of screens, to be shown within the C³ISI screen, that show and/or calculate the needed data for a Decision. Users can program a process in C³ISI where they are moved within the screen from one application or source to another application or source at a time, in a predetermined manner or in a manner determined by analysis and the data available.

The C³ISI, where the C³ISI system uses the data that it gathers from numerous other systems, to make calculations, predictions, analysis that are not available in any one of the existing systems, and save these to be used again.

The C³ISI, where the C³ISI has a System Input Screen (C³ISISIS), which exists as one of the many screens that the user may select to show up within the C³ISI, and represents a powerful program with a set of tools designed to allow the user to make many inputs that drive the C³ISI and the way that it appears, makes calculations, or in general interacts with the remainder of the screens and performs tasks for the user.

The C³ISI, where the user selects 1) all of the user configurable options within the C³ISI, 2) a wide range of traditional reports, exception reports, graphics, and any other tools that would allow the user to get the information they want presented in the way that they want, 3) input instructions for the C³ISI to perform calculations based on information from any of the screens that are available within the C³ISI and present the results as described in prior examples while also showing each screen where the data came from as a drill down within the calculation, so the user can readily understand not only the results but also see where the data came from, 4) input something that they want to look at, and the C³ISI will find all the references to that object, in any screen or system available to the C³ISI, and show those screens at the places in the systems within each screen where the object is shown in reference. The user could put in a future date and the C³ISI would automatically bring out every screen that has information about that date,

The C³ISI, where the C³ISI will not only perform the functions in the prior examples, but will also create a report for the user that shows all of the references to the item that the user input and said they wanted to see. This report can be customized by the user or it can be a system default report and this input and the resulting report, whether customized or not, can be stored and called upon where the user simply inputs a new value for the input field, for instance a new date, and the screens are pulled up the values are retrieved and the report is filled out, and the user can see the report and then have instant access to view all of the screens from all the different systems are the report derived the data.

I claim:

1. A computerized method of predicting a plurality of behavioral events of an entity, comprising:
programming a computer to statistically analyze data describing a plurality of entities in order to construct a plurality of behavioral patterns for each one of a plurality of different types of behavior; and
programming the computer to analyze data related to a first one of the plurality of different types of behavior of an entity in order to associate the entity with a particular one of the plurality of behavioral patterns such that the particular one of the plurality of behavioral patterns serves as a first predictive behavioral pattern, wherein the first predictive behavioral pattern:
predicts a plurality of a first type of behavioral events of the entity occurring over any amount of time up to a lifetime of the entity, and
the plurality of the first type of behavioral events are of the first one of the plurality of different types of behavior;
programming the computer to analyze data related to a second one of the plurality of different types of behavior of an entity in order to associate the entity with a particular one of the plurality of behavioral patterns such that the particular one of the plurality of behavioral patterns serves as a second predictive behavioral pattern, wherein the second predictive behavioral pattern:
predicts a plurality of a second type of behavioral events of the entity occurring over any amount of time up to a lifetime of the entity, and
the plurality of the second type of behavioral events are of the second one of the plurality of different types of behavior; and
programming the computer determine an amount of correlation between the first predictive behavioral pattern and the second predictive behavioral pattern.

2. The computerized method according to claim 1, which comprises: programming the computer to determine which portions of the first predictive behavioral pattern and the second predictive behavioral pattern are not correlated.

3. The computerized method according to claim 1, which comprises: programming the computer to determine which actions to direct to the entity based on the amount of correlation between the first predictive behavioral pattern and the second predictive behavioral pattern.

4. The computerized method according to claim 1, which comprises: programming the computer to determine which entities receive a particular action based on the amount of correlation between the first predictive behavioral pattern and the second predictive behavioral pattern.
